(19) United States
(12) Patent Application Publication
(10) Pub. No.: US 2026/0052459 A1
(43) Pub. Date: Feb. 19, 2026

(54) Methods and Apparatus for Generating, Communicating and/or Using Network Energy Related Information

(71) Applicant: Charter Communications Operating, LLC, St. Louis, MO (US)

(72) Inventors: Inmaculada Carrion Rodrigo, Valley Center, CA (US); Vinayak K. Thotton Veettil, Parker, CO (US); Melissa Romero Garcia, Greenwood Village, CO (US)

(21) Appl. No.: 19/301,851

(22) Filed: Aug. 15, 2025

Related U.S. Application Data
(60) Provisional application No. 63/684,337, filed on Aug. 16, 2024.

(51) Int. Cl. H04W 48/18; H04W 48/16; H04W 72/044

(52) U.S. Cl. CPC H04W 48/18; H04W 48/16; H04W 72/0473

(57) ABSTRACT

Methods and apparatus for generating and communicating network energy ratings to use in selecting communications networks are described. The network energy rating of a network is based on one or more factors including how environmentally friendly the energy sources used by the network are and/or how efficient the communications network uses energy. UEs generate energy ratings for communications networks with the energy rating of a communications network depending on how efficiently, from an energy perspective, the UE can communicate with the network to which the energy rating corresponds. Network energy scores corresponding to different networks are communicated to devices in the network, including UEs. The network energy score can be taken into consideration when making a communications network selection for a UE. UE generated energy network ratings can be and sometimes are considered and used in addition to network energy scores when making a communications network selection for a UE.

### RELATED APPLICATIONS

The present application claims the benefit of U.S. Provisional Patent Application Ser. No. 63/684,337 which was filed on Aug. 16, 2024 and which is hereby expressly incorporated by reference in its entirety.

### FIELD

The present application relates to wireless communications and, more particularly, to methods and apparatus for generating, communicating and/or using network energy related information such as a network energy score and/or a network energy rating.

### BACKGROUND

Various technologies have been developed to allow a wireless communications device to support the use of different networks. For example, an embedded subscriber Identity Modules (e-SIM) can be used in combination with a physical (p-SIM) in some devices to support different profiles with each profile in some cases corresponding to a communications network to which the device can attach and obtain services. Some devices can include multiple e-SIMs or other identifiers allowing the device to support connectivity to multiple networks.

5G System (5GS) support enhanced mechanisms for steering and switching of user data, pertaining to a user equipment (UE) data session, across two 3GPP networks.

Two Public Land Mobile Network (PLMN) subscriptions (2 Subscription Permanent Identifiers (SUPIs)) can be associated with a device, e.g., UE, with each subscription having their own operator policies. The two PLMN subscriptions may correspond to 3GPP networks that use same or different Radio Access Technology (RAT), i.e. New Radio (NR) plus NR or Evolved UMTS Terrestrial Radio Access (E-UTRA), where NR RAT can be terrestrial or satellite NR access (including different satellite orbits, e.g., Geostationary Earth Orbit/Medium Earth Orbit/Low Earth Orbit (GEO/MEO/LEO). A Public Land Mobile Network identifier (PLMNID) and an sometimes is used to identify a PLMN.

For the PLMN plus PLMN/Public Network Integrated-Non-Public Network (PNI-NPN) scenarios, the two networks can be managed by the same operator or by different operators with the different operators having a business agreement between them in some cases.

A device capable of connecting to two networks is sometimes referred to as a dual steer device. A dual steer device in some cases can support traffic steering and switching of user data (for different services) across two 3GPP access networks.

While a device may be able to attach to different networks, simple selections based on a static fixed network priority list fails to take into consideration a variety of factors including potentially power efficiency associated with using a network and/or green energy considerations such as the energy source, e.g., coal, natural gas, nuclear, or renewable such as wind/solar, used to power the network or mix thereof used to power a network which a device, e.g., User Device (UE) might attach to or use for communication purposes.

While methods improved methods for making network and/or profile selection decisions are needed, there is also a need for methods of collecting and distributing information which can be used in making network/profile selection decisions. For example, it would be beneficial if methods and/or apparatus could be developed for collecting and communicating information about the types of energy sources that are used by networks and/or power consumption a device is likely to encounter when using a network so that such information can be used when making network attachment/use decisions by individual devices, e.g., UEs.

In view of the above it should be appreciated that there is a need for improved methods and apparatus relating to collecting and distributing information relating to energy sources and/or expected energy consumption associated with using one or more available networks. There is also a need for improved control of profile and/or network selection by user devices seeking to obtain services from one or more wireless networks. In particular it would be desirable if methods and/or apparatus could be developed which allowed a device to make decisions with regard to what network to attach to or profile to be used taking into consideration energy related factors such as power consumption and/or the type of energy source or sources being used by a network.

### SUMMARY

Methods and apparatus for generating and communicating network energy ratings which can be used in selecting communications networks to use are described. The network energy rating of a network can be and sometimes is based on one or more factors including how environmentally friendly the energy sources used by the network are and/or how efficient the communications network uses energy. User Equipments (UEs), in some but not necessarily all embodiments, generate energy ratings for communications networks with the energy rating of a communications network depending on how efficiently, from an energy perspective, the UE can communicate with the network to which the energy rating corresponds.

The term/phrase UE device and UE are used interchangeably in the present application. UEs is used as the plural of UE to refer to multiple devices.

Network energy scores corresponding to different networks are communicated to devices in the network, including UEs. This allows the network energy score to be taken into consideration when making a communications selection for a UE, e.g., at the time of initial network selection and connection, network handover and/or network reselection. UE generated energy network ratings can be and sometimes are considered and used in addition to network energy scores when making a communications network selection for a UE.

Computation of network energy scores can be performed in any of a variety of network devices and/or operating system components and need not be performed in a specific device. UE generated energy ratings are normally generated in the UE and communicated to one or more network devices. In this way UE specific characteristics and/or results in communicating with a communications network can be taken into consideration when selecting a communications network for a UE based on energy considerations.

While initial communications network selection, network handover and network reselection operations may and sometimes do involve use of one or both of a network energy score and UE calculated communications network energy rating, the network energy score and/or UE calculated network energy rating can be used and in sometimes are used in determining when to implement any of a variety of energy saving operations in the UE and/or communications network being used by a UE.

Features of the present invention relate to one or more of: i) improvements for roaming partners dynamic update to roaming/partner selection policies into to the UE; ii) improvements for controlling roaming/network selection based on energy efficiency aspects; iv) improvements from having an standardized solution rather having a dependency on the application level providers like Google and Apple; and/or v) improvements to hand it/out procedures potentially saving energy as well as avoiding ping-pong situations, and/or excessive scanning, e.g., for networks.

In various embodiments a control device, e.g., server, coupled to various different service provider networks and having access to the status, loading and/or condition of the networks, is used to influence network selection and use taking into consideration the capabilities of individual devices and the multiple service subscriptions at least some devices have which allow them to use a variety of different overlapping networks, e.g., where network coverage of different service providers overlap.

In some embodiments a control device receives information, e.g., network status information, power consumption information, green energy scores corresponding to different networks and network loading information, from a plurality of service provider networks and/or user devices. The control device also receives device capability information and status information, from a plurality of user equipment (UE) devices as well as power consumption reports and/or power consumption scores generated by UEs for networks with which they are communicating. One or more UEs subscribe to multiple service provider networks. In some geographical regions, coverage is provided by more than one network. The control device generates and sends device profile to network mapping information to UEs on an individual UE basis, e.g., for each of one or more geographic regions, e.g., 3D regions, where multiple networks are available. The network selection information can be based on power consumption and/or green energy scores associated with networks.

The generated device profile information may be pushed to the UE device by the control server, e.g., when a network condition or loading change is detected for example, or requested by an individual UE, e.g., because of a change in UE communications needs or a change in network conditions detected by the UE. In addition, depending on the embodiment individual UEs may poll for updates of the information used for profile/network selection on a schedule or periodic basis depending on the embodiment.

The device profile to network mapping information sometimes includes criteria, e.g., rules, parameter, limits, etc. An application on the UE uses the received device profile to network mapping information along with position information to select a network/profile to use at a given time. The control device can implement load balancing between networks by altering the information provided to one or more UEs.

A communications system includes in at least some embodiments a plurality of different service provider networks. A user equipment device, e.g., including a physical Subscriber Identity Module (p-SIM) and an embedded subscriber Identity Module (e-SIM), includes the capability to access a set of service provider networks. Different UEs may be able to access different sets of networks. Different networks provide access to different geographical regions, e.g., depending upon the location of their access devices, e.g., base stations, access points, gateways, etc., and their operational ranges. In some regions a combination of alternative networks are available to be used by one or more of the UE devices.

A control device, e.g. a control server, collects information from: i) the service provider networks, e.g., including location information, network loading and network status information, and ii) the UE devices, e.g., including device type information, device capability information, device location information, subscription information, latency information, and resource requirements/needs information. The control device, with an overall view of the system, processes the received information and generates network power consumption scores and/or green energy scores. UE device profile to network mapping information, e.g. service bubble information, for different geographical regions, on an individual UE basis. The UE device profile to network mapping information is communicated from the control device to the UE, which stores the set of information. The UE device uses the profile to network mapping information to determine, e.g. select, a particular network or networks to use in a particular geographic region. The selection can depend on power consumption scores and/or green energy scores.

The UE device profile to network mapping information may, and sometimes does, specify a particular network to be used by the UE in a particular geographic region. This information in the UE may be, and sometime is, updated by the control server based on network changes, e.g., to achieve load balancing and/or to provide the UE a desired level of quality of service as the capability of some networks to provide service changes over time. In some embodiments, the UE device profile to network mapping information includes selection criteria, e.g., rules, limits, identified parameters to be evaluated, to be used by the UE in making a selection decision among a plurality of alternative available networks. A UE device can monitor for networks and choose to select to switch to or connect to a network with a better power consumption score or green energy score than the network with which is currently attached even though the communications quality of the current connection remains satisfactory.

Thus, in some embodiments, the control device, which has an overall view of the entire system, generates and sends network selection criteria, e.g., including rules to be evaluated, to an individual UE device for a particular geographic region. The selection criteria can include power considerations, e.g. network power score and/or green energy score considerations or selection related logic. This information supplied from the control device is typically intended to be used by the UE device for an extended period of time, e.g., in some embodiments, the UE makes many, e.g., several, hundreds or even thousands of network selections in some but not all embodiments, using this supplied criteria, before the information is updated. However, in the case of a network change the control device may promptly update the information, e.g., within minutes of a change in load or a network's ability to provide a desired quality of service level. Thus, while the network selection criteria may be used for a period of time it is far from a static list which does not change in that when a change is desirable the control server can update the selection information in one or more UEs in minutes and/or hours to alter the relative load between networks and/or for other reasons. Furthermore, the network selection rules and/or criteria provide flexibility in some cases with the network and/or profile selection criteria, rules and other information being, in some but not necessarily all embodiments more than a simple network or priority list.

The UE device uses the supplied criteria and current information known to the UE, e.g., its current data backlog, its current latency requirements, its current battery status, its current set of applications running, etc., to make the final determination as to the network to use at the present time. Thus, in some embodiments, the refined network selection process for a UE in a particular geographic region, in which there are alternative networks, benefits from the overall system knowledge of the control device and the individual current UE device status/needs knowledge.

In some embodiments, the network control device performs overall networks' load balancing by performing and/or influencing network selection for individual UEs on a per geographical region basis.

An exemplary method of operating a control device, e.g., a control server, in accordance with some embodiments, comprises: storing network information for a plurality of communications networks said network information including network type, geographic coverage area and supported data rate information; monitoring status of at least some of said communications networks; storing device profile information for at least a first communications device, said first communication device being capable of connecting to a plurality of communications networks, said device profile information including first device profile information including information for a plurality of device profiles which can be used by the first communications device, said first device profile information including at least a first profile corresponding to a first network and a second profile corresponding to a second network; and generating first device geographic region to profile mapping information, said first device geographic region to profile mapping information specifying: i) one or more rules, ii) information and/or iii) rules and information used to map geographic regions to one of the device profiles available to be used by the first communications device. While various features discussed in the summary are used in some embodiments it should be appreciated that not all features are required or necessary for all embodiments and the mention of features in the summary should in no way be interpreted as implying that the feature is necessary or critical for all embodiments.

In some embodiments, rather than having a single centralized control device, interfacing with multiple service provider networks, collecting and processing energy efficiency related data from the multiple service provider networks, and exercising control with regard to energy efficiency over the multiple server provider networks, each of one or more individual service provider network has its own network management device, which collects and processes energy efficiency related data for its own network and exercises control with regard to energy efficiency over its own service provider network.

Numerous aspects, features, and variations on the above described methods and apparatus are discussed in the detailed description which follows.

### BRIEF DESCRIPTION OF THE FIGURES

FIG. 1 is a drawing illustrating a plurality of service provider networks, which may be included as part of an exemplary communications system.

FIG. 2 is a drawing of an exemplary communications system, which includes the service provider networks of FIG. 1 in accordance with an exemplary embodiment.

FIG. 3 is a drawing of an exemplary user equipment (UE) device in accordance with an exemplary embodiment, said UE device supporting a physical SIM (p-SIM) card and at least one of i) an e-SIM car or ii) an i-SIM card.

FIG. 4 is a drawing of an exemplary control device, e.g., a control server, in accordance with an exemplary embodiment.

FIG. 5 is a drawing of an exemplary network management device, e.g., a network management node, in accordance with an exemplary embodiment.

FIG. 6 is a drawing of a flowchart of an exemplary method of calculating a composite energy score for a service provider network (also sometimes referred to as a network energy score), communicating the calculated network energy score to radio units in base stations of the network, and operating the radio units to communicate, e.g. broadcast, the network energy score to UEs.

FIG. 7A is a first part of a flowchart of an exemplary method of operating a UE, in accordance with an exemplary embodiment, said exemplary method including recovering communicated energy scores corresponding to different networks and generating UE energy ratings corresponding to different networks.

FIG. 7B is a second part of a flowchart of an exemplary method of operating a UE, in accordance with an exemplary embodiment, said exemplary method including recovering communicated energy scores corresponding to different networks and generating UE energy ratings corresponding to different networks.

FIG. 7C is a third part of a flowchart of an exemplary method of operating a UE, in accordance with an exemplary embodiment, said exemplary method including recovering communicated energy scores corresponding to different networks and generating UE energy ratings corresponding to different networks.

FIG. 7 comprises the combination of FIG. 7A, FIG. 7B and FIG. 7C.

FIG. 8 is a flowchart of an exemplary network decision based UE handover/network re-selection method in accordance with an exemplary embodiment.

FIG. 9 is a flowchart of an exemplary UE decision based UE handover/network re-selection method in accordance with an exemplary embodiment.

FIG. 10 is a drawing of an exemplary network access device, e.g., a base station or access point, in accordance with an exemplary embodiment.

### DETAILED DESCRIPTION

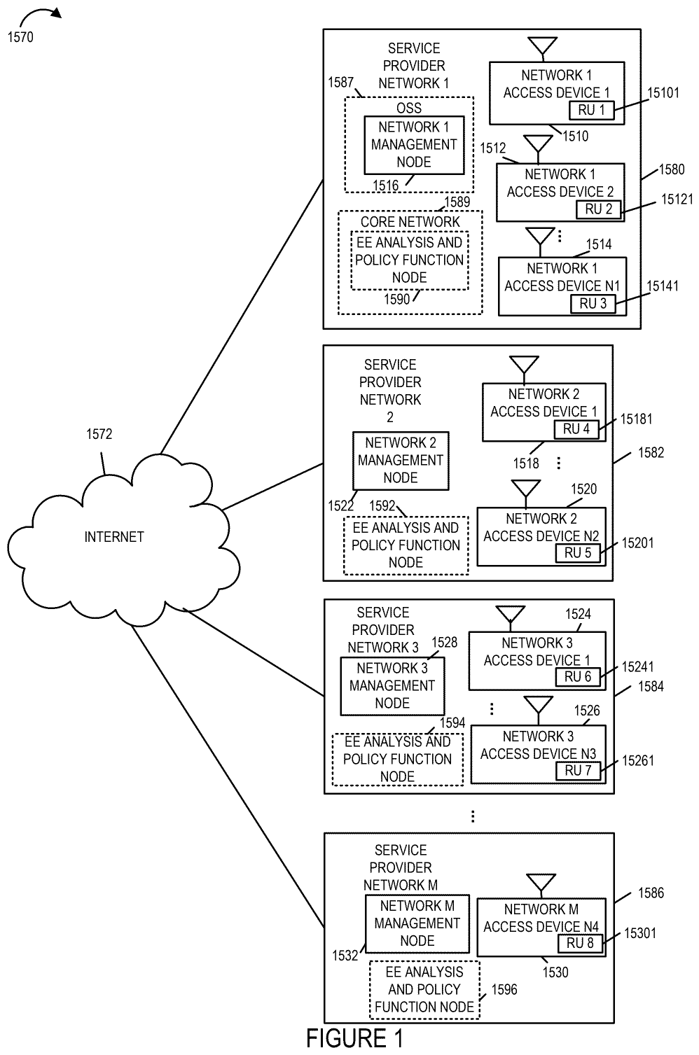

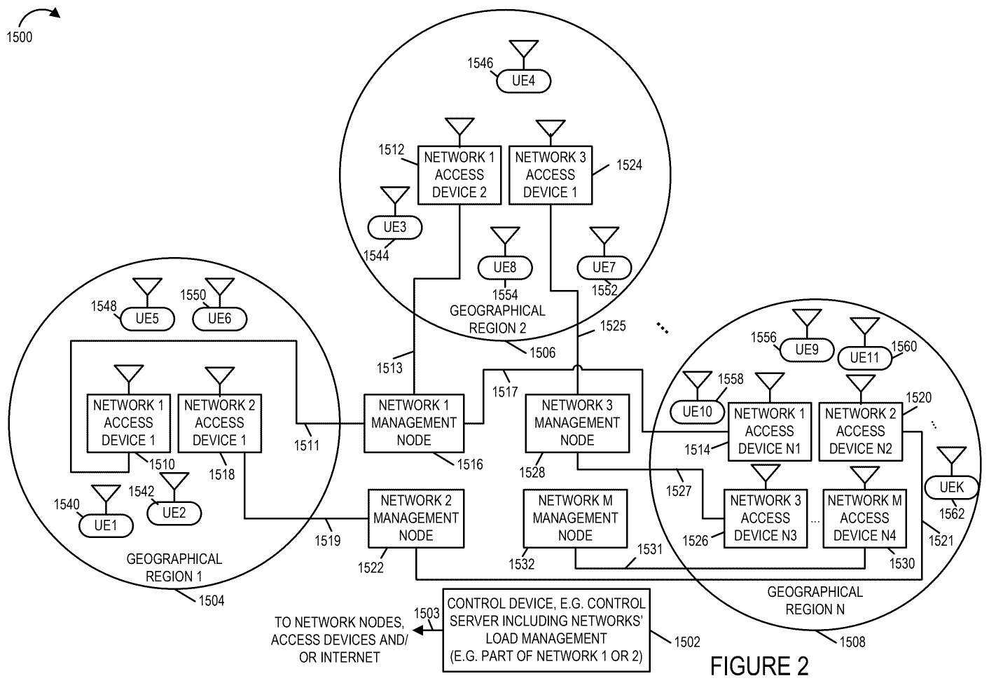

FIG. 1 is a drawing 1570 illustrating a plurality of service provider networks (service provider network 1 1580, service provider network 2 1582, service provider network 3 1584, . . . , service provider network M) coupled to Internet 1572. Service provider network 1 1580 includes a network 1 management node 1516 and a plurality of network 1 access devices (network 1 access device 1 1510, network 1 access device 2 1512, . . . , network 1 access device N1 1514). Service provider network 2 1582 includes a network 2 management node 1522 and a plurality of network 2 access devices (network 2 access device 1 1518, . . . , network 2 access device N2 1520). Service provider network 3 1584 includes a network 3 management node 1528 and a plurality of network 3 access devices (network 3 access device 1 1524, . . . , network 3 access device N3 1526). Service provider network M 1586 includes a network M management node 1532 and one or more of network 3 access devices including network M access device N4 1530. Each of the network access devices (1510, 1512, 1514, 1518, 1520, 1524, 1526, 1530) includes one or more radio units (RUs). Network 1 access device 1 1510 includes RU 1 15101; network 1 access device 2 1512 includes RU 2 15121; and network 1 access device N1 1514 includes RU 3 15141. Network 2 access device 1 1518 includes RU 4 15181; and network 2 access device N2 1520 includes RU 5 15201. Network 3 access device 1 1524 includes RU 6 15241 and network 3 access device N3 1524 includes RU 7 15241. Network M access device N4 1530 includes RU 8 15301. network 2 access device 2 1520 includes RU 5 15201. Wireless coverage areas of the different service provider networks (1580, 1582, 1584, 1586) overlap as shown in FIG. 2.

In some embodiments, each of the network management nodes (1516, 1522, 1528, . . . , 1532) are included as part on an Operation Support System (OSS) of the network (1516, 1522, 1528, . . . , 1532). For example, network 1 management node 1516 is, in some embodiments, part of OSS 1587. In some embodiments, each of the networks (1580, 1582, 1584, . . . , 1586) includes an Energy Efficiency (EE) analysis and policy function node (1590, 1592, 1594, . . . , 1596), respectively. In some embodiments, the EE analysis and policy function is implemented as a dedicated network function, e.g., as part of a core network which is part of the service provider network (1580, 1582, 1584, . . . , 1586). For example, EE policy function node 1590 is, in some embodiments, part of core network 1589.

FIG. 2 is a drawing of an exemplary communications system 1500 in accordance with an exemplary embodiment. Exemplary communications system 1500 includes a control device 1502, e.g. a control server including networks' load management capabilities. Control device 1502 is coupled to network nodes, access nodes and/or the Internet via connection 1503. Exemplary communications system 1500 includes a plurality of networks (network 1 1580, network 2 1582, network 3 1584, . . . , network M 1586) coupled together. Network 1 1580 includes a plurality of network 1 access devices, e.g. network 1 cellular base stations, (network 1 access device 1 1510, network 1 access device 2 1512, . . . , network 1 access device N1 1514) and network 1 management node 1516 coupled together via communications links (1511, 1513, . . . , 1515), respectively. Network 2 1582 includes a plurality of network 2 access devices, e.g. network 2 cellular base stations or WiFi access points, (network 2 access device 1 1518, . . . , network 2 access device N2 1520) and network 2 management node 1522 coupled together via communications links (1519, . . . , 1521), respectively. Network 3 includes a plurality of network 3 access devices, e.g. network 3 cellular base stations, or CBSD base stations, or LoRa base station, or IoT gateways, or BLE base stations, (network 3 access device 1 1524, . . . , network 3 access device N3 1526) and network 3 management node 1528 coupled together via communications links (1525, . . . , 1527), respectively. Network M includes a plurality of network M access devices, e.g., network 4 cellular base stations, including network M access device N4 1530 and network M management node 1532 coupled together via communications link 1531.

Exemplary communications system 1500 further includes a plurality of user equipment (UE) devices (UE 1 1540, UE 2 1542, UE 3 1544, UE 4 1546, UE 5 1548, UE 6 1550, UE 7 1552, UE 8 1554, UE 9 1556, UE 10 1558, UE 11 1560, . . . , UE K 1562). At least some of the UEs are mobile devices which may move throughout the communications system 1500. The coverage area of the communications system 1500 includes a plurality of geographic regions (geographical region 1 1504, geographical region 2 1506, . . . , geographical region N 1508). Network 1 access device 1 1510 and network 2 access device 2 provide wireless coverage in geographical region 1 1504. Network 1 access device 2 1512 and network 3 access device 1 provide wireless coverage in geographical region 2 1506. Network 1 access device N1 1514, network 2 access device N2 1520, network 3 access device N3 1526 and network M access device N4) provide wireless coverage in geographical region 3 1508. In some embodiments, at least some of the coverage areas of network access devices, corresponding to the same service provider network, partially overlap. In some embodiments, different network access devices may, and sometimes do, have different size coverage areas. In some embodiments, the different service provider networks may, and sometimes do, have different size cellular coverage areas. In some embodiments. Different UEs may, and sometimes do, have different capabilities with regard to connectivity to networks. At least some of the UEs are capable of connecting to a plurality of different networks. In some embodiments, at least some of the UEs include i) a physical Subscriber Identity Module (p-SIM) card and ii) an embedded SIM (e-SIM) or integrated SIM (i-SIM).

In some embodiments, the control device 1502 is included as part of one of the networks in system 1500, e.g., as part of network 1 or network 2. In embodiments, control device 1502 is one of the network management nodes, e.g. control device 1502 is network 2 management node 2 1522 or network 1 management node 1516. The control device 1502 receives information from the networks and UE devices and determines service bubble information for the UEs, e.g., on an ongoing basis. A set of service bubble information is communicated to each individual UE including information to be used by the UE to determine which network to use, e.g. in a particular geographical region at a particular time under a particular set of observed conditions. In some embodiments, the service bubble information may, and sometimes does, includes information specifying which network is to be used by the UE in a particular geographical region. In some embodiments, the service bubble information may, and sometimes does, include information specifying criteria, e.g., including rules and parameters, to be used by the UE in determining which one of a plurality of alternative networks is to be selected to be used by the UE in a particular geographical region. Service bubble information is updated on an ongoing basis, e.g. in response to detected network changes, e.g. loading changes, fault conditions, etc. and/or UE device status changes, e.g. in battery power, applications running, amount of data to be transmitted, location, latency requirements, QoS required, measured interference levels, measured SNR, detected signal strength levels, user subscriptions to networks and/or services, etc.

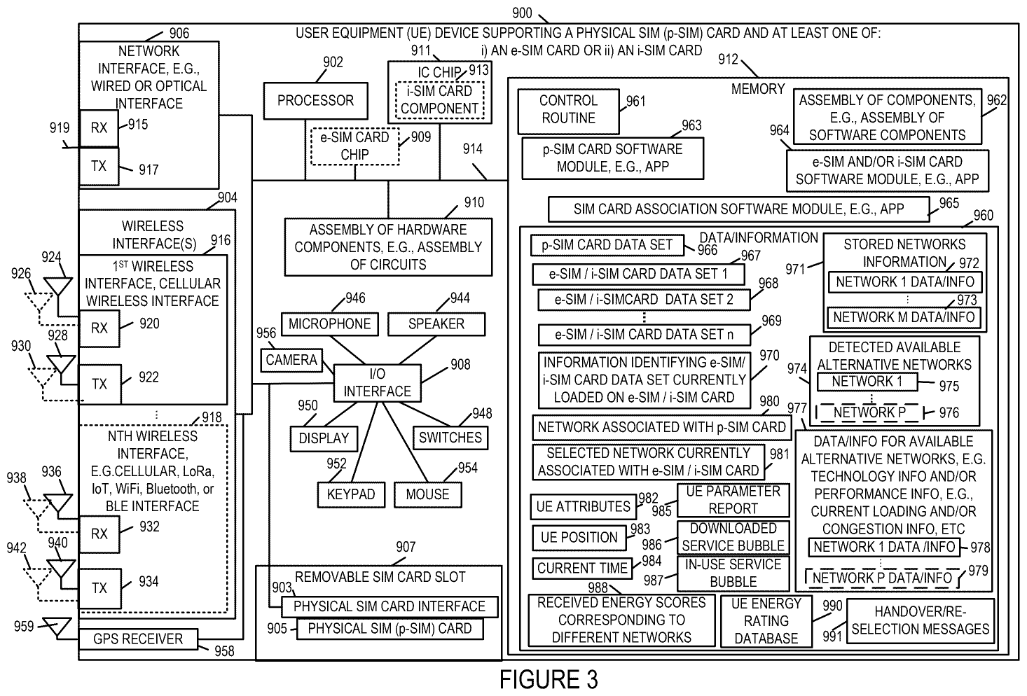

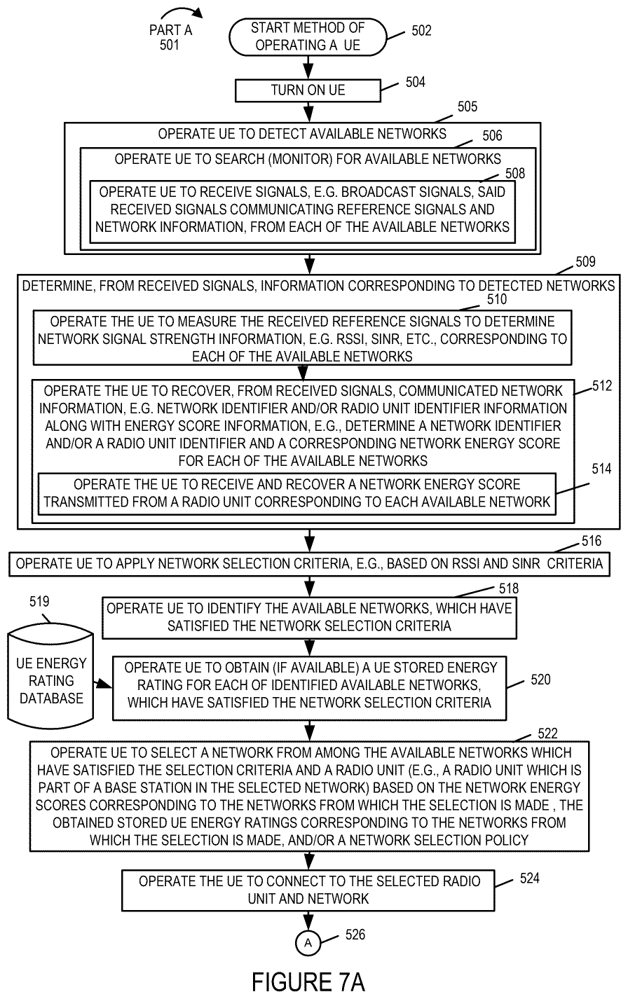

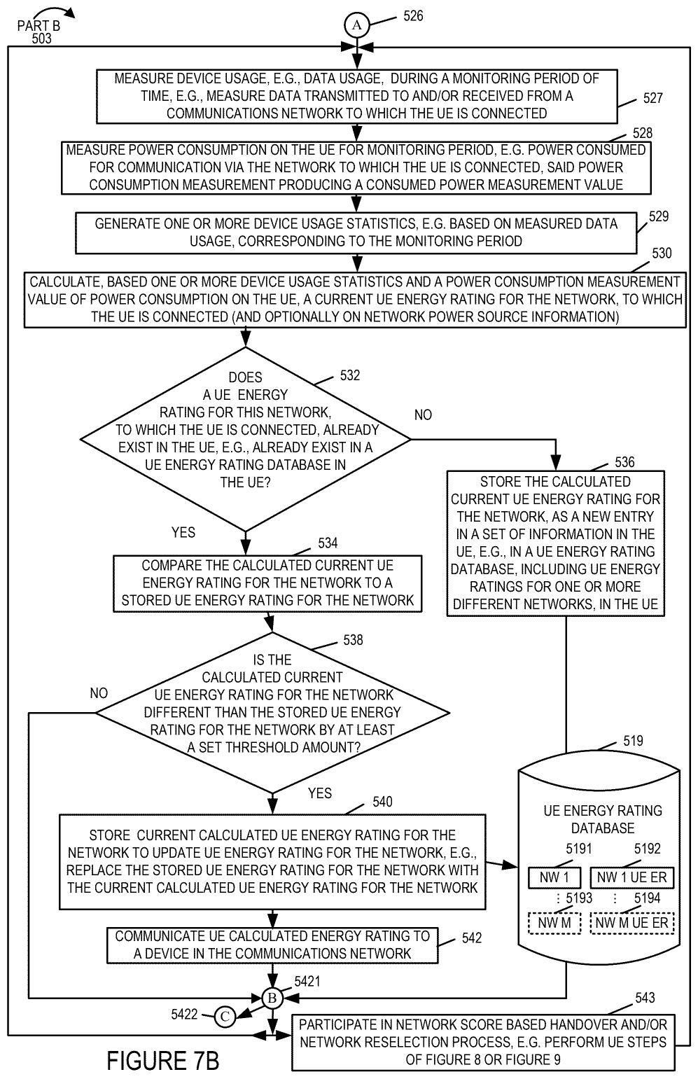

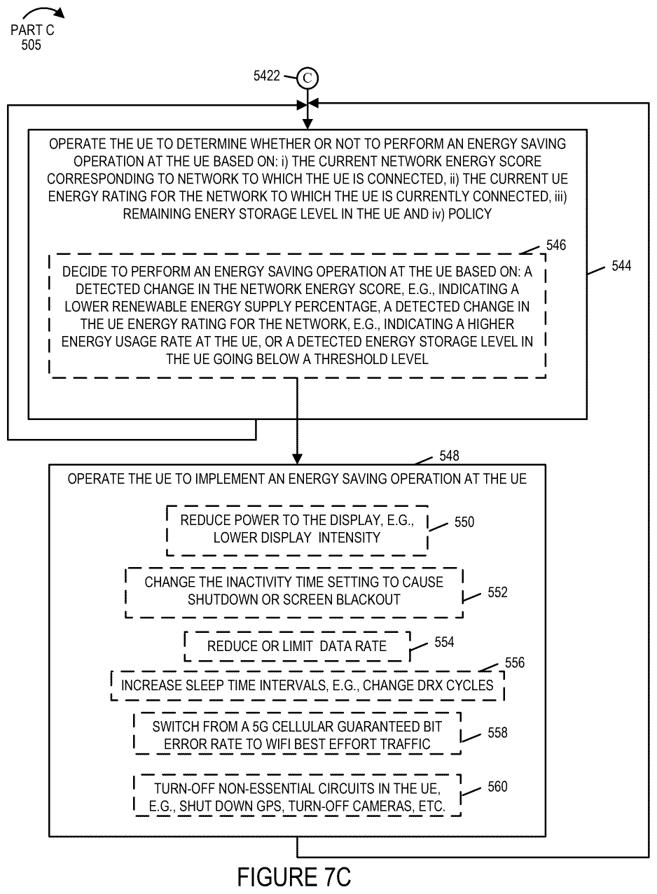

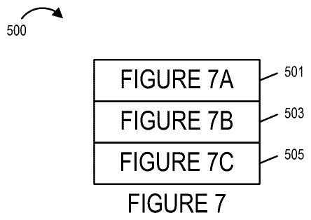

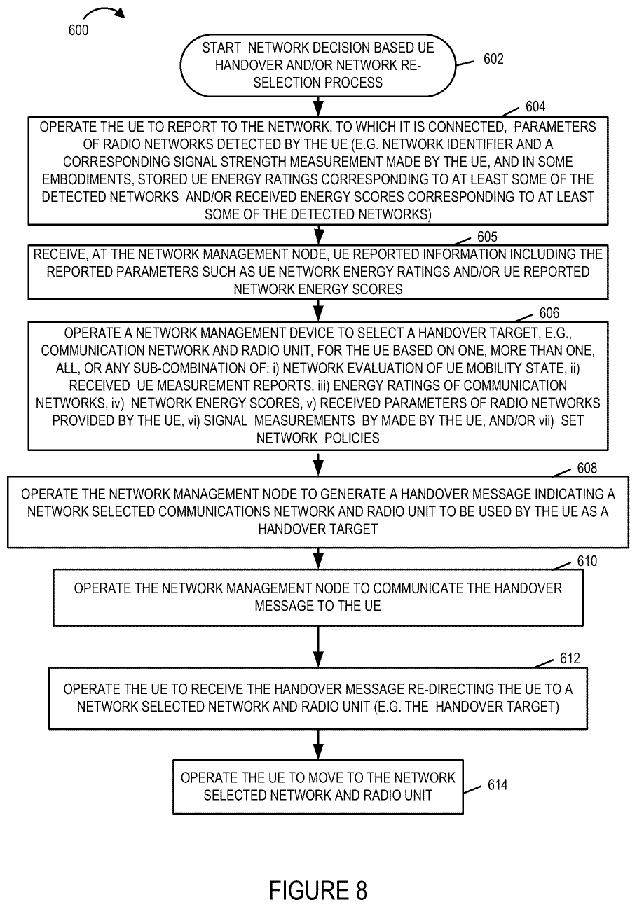

FIG. 3 is a drawing of an exemplary user equipment (UE) device 900 in accordance with an exemplary embodiment, said UE device supporting a physical SIM (p-SIM) card and at least one of i) an embedded SIM (e-SIM) card or ii) an integrated SIM (i-SIM) card. UE device 900 is, e.g., any of UEs (UE 1 1540, UE 2 1542, UE 3 1544, UE 4 1546, UE 5 1548, UE 6 1550, UE 7 1552, UE 8 1554, UE 9 1556, UE 10 1558, UE 11 1560, . . . , UE K 1562) of FIG. 2, a UE implementing the method of flowchart 200 of FIG. 3, a UE implementing the method of flowchart 500 of FIG. 7, a UE implementing steps, performed by a UE, of the method of flowchart 600 of FIG. 8, a UE implementing steps, performed by a UE, of the method of flowchart 700 of FIG. 8 and/or a UE device described with respect to any of the Figures.

UE device 900 includes a processor 902, e.g., a CPU, wireless interfaces 904, network interface 906, an I/O interface 908, an assembly of hardware components 910, e.g., an assembly of circuits, memory 912, a physical SIM (p-SIM) card interface 903, and a Global Positioning System (GPS) receiver 958 coupled to bus 914, via which the various elements may interchange data and information. UE device 900 includes a physical SIM (p-SIM) card 905 within its removable SIM card slot 907 and coupled by physical SIM card interface 903 to bus 914. Exemplary UE device 900 includes one or both of: an e-SIM card chip 909 coupled to bus 914, or ii) an IC chip 911 including an i-SIM card component 913 coupled to bus 914.

Wireless interfaces 904 includes a plurality of wireless interfaces (1st wireless interface 916, e.g., a cellular wireless interface, . . . , Nth wireless interface 918, e.g., a cellular wireless interface, LoRa interface, a IoT interface, a WiFi interface, a Bluetooth interface, or a Bluetooth low energy (BLE) interface). 1st wireless interface 916 includes a wireless receiver 920 coupled to one or more receive antennas or antenna elements (924, . . . , 926) and a wireless transmitter 922 coupled to one or more transmit antennas or antenna elements (928, . . . , 930). Nth wireless interface 918 includes a wireless receiver 932 coupled to one or more receive antennas or antenna elements (936, . . . , 938) and a wireless transmitter 934 coupled to one or more transmit antennas or antenna elements (940, . . . , 942). Network interface 906, e.g., a wired or optical interface, includes a receiver 915 and a transmitter 914, coupled to output connector 919.

UE 900 further includes a plurality of I/O devices (speaker 944, microphone 946, switches 948, display 950, e.g., a touch screen display, keypad 952, mouse 954, and camera 956) coupled to I/O interface 808, which couples the I/O devices to bus 914 and to other elements in device 900.

Memory 912 includes a control routine 961, an assembly of components 962, e.g., an assembly of software components, e.g., routines, subroutines, modules, etc., a p-SIM card software module 963, an e-SIM and/or i-SIM card software module 964, a SIM card association software module 965, and data/information 960. Data/information 960 includes a p-SIM card data set 966, a plurality of e-SIM and/or i-SIM card data sets (e-SIM/i-SIM card data set 1 967, e-SIM/i-SIM card data set 2 967, . . . , e-SIM/i-SIM card data set n 969), and stored networks information 971. Stored networks information 971 includes information corresponding a plurality of networks, e.g., networks to which the user of device 900 has a subscription, (network 1 data/information 972, . . . , network M data/information 973). Data/information 960 further includes detected available alternative networks 974, e.g., a list of detected available alternative networks which may be used by UE 900 at its current location (network 1 975, . . . , network P 976), and data/information 977 for available alternative networks, e.g., technology information and/or performance information, e.g., current loading information and/or congestion information, etc. (network 1 data/information 978, . . . , network P data/information 979). Technology information includes, e.g., type of interface and/or protocol being used by the network, e.g., WiFi, Bluetooth, BLE, IoT, LoRa, etc., power level information and/or number of UEs which can supported concurrently by the network, e.g., by an access point or base station or GW.

Data/information 960 further includes information 970 identifying an e-SIM/i-SIM card data set currently loaded on an e-SIM/i-SIM card, a network associated with the p-SIM card 980, a selected network currently associated with e-SIM/i-SIM card 981, UE attributes 982, UE position 983, current time 984, a generated UE parameter report 985 to be sent to a server, a downloaded service bubble 984, e.g. an updated service bubble downloaded from a server, and a current in-use service bubble 985 including, e.g., informing including pairing of particular networks with particular sets of criteria at particular locations, e.g. used for network selection.

Data/information 912 further includes received energy scores 988 corresponding to different networks (e.g., a received energy score (e.g., network energy score) corresponding to each of: service provider network 1 1580, service provider network 2 1582, service provider network 3 1584, and service provider network M 1586), a UE energy rating database 990, which includes a UE generated energy rating corresponding to each of the network to which the UE has been connected, and UE handover/network re-selection messages 991.

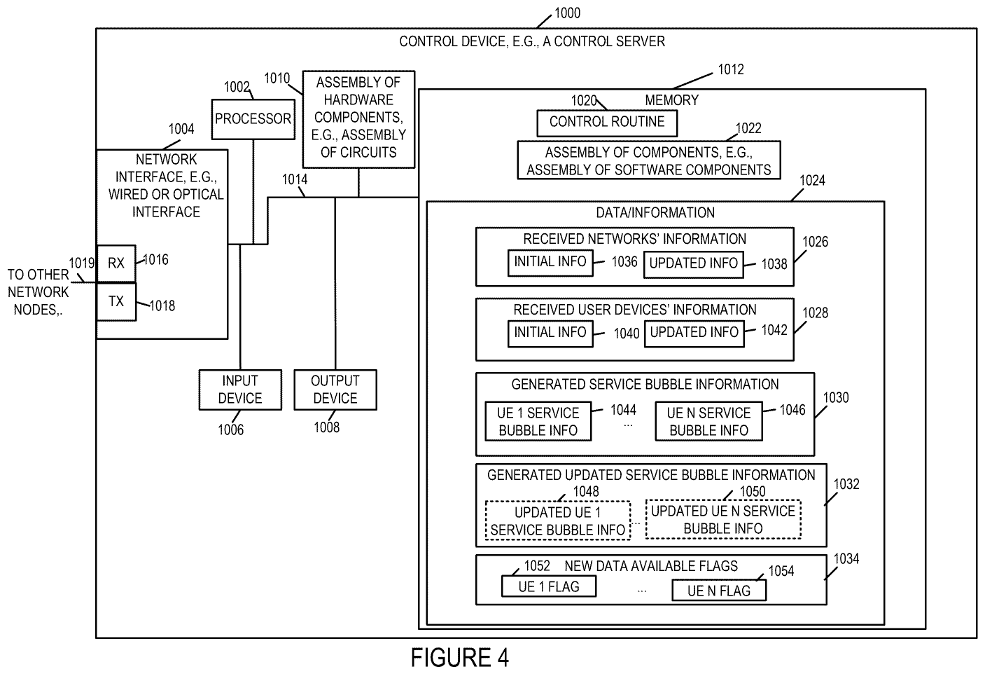

FIG. 4 is a drawing of an exemplary control device 1000, e.g., a control server, in accordance with an exemplary embodiment which, in some embodiments, collects power consumption information and/or power scores generated by UEs, generates power scores or other network related information from information received from networks and/or UEs and which sends information including profiles to base stations for communication to wireless devices, e.g., UEs. The server, in some embodiments, can be, and sometimes is, also involved in handoff decisions and can communicate to a wireless device a handoff command and/or handoff information which may be mandatory or recommended. Along with the handoff command can be an indicator indicating whether it is mandatory or optional and power related information can be provided and sometime is provided with the handoff information to facilitate wireless device network selection by providing information allowing a UE to make an informed decision with regard to energy consumption and/or whether the network base station which is the target of the handoff is considered sufficiently “green” from an energy policy perspective.

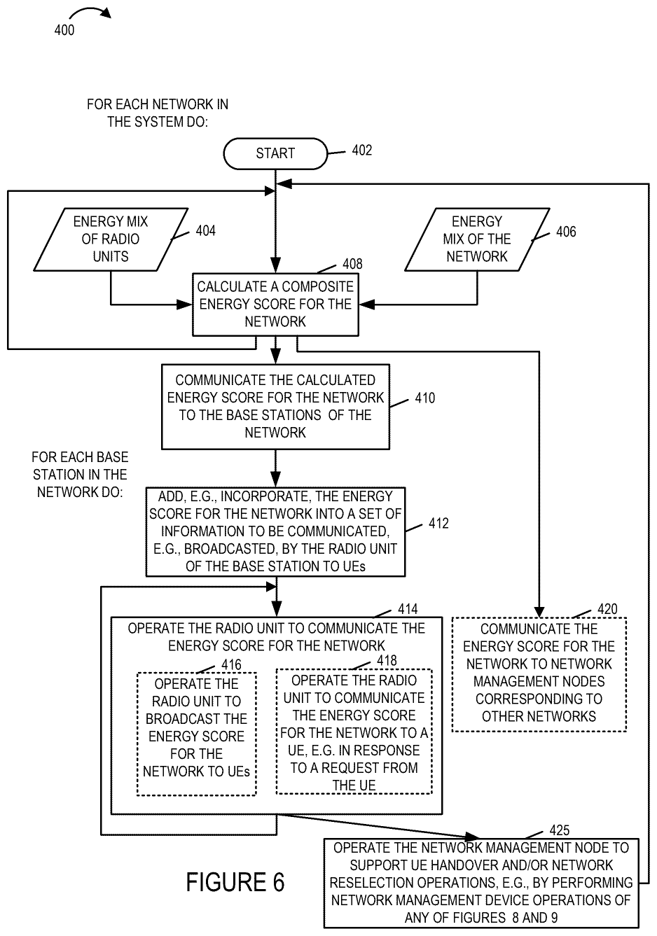

Control device 1000 is, e.g., any of control device 1502 of FIG. 2, a server implementing steps of the method of flowchart 400 of FIG. 6 and/or a control device or server described with respect to any of the Figures. In some embodiments, control device 1000 calculates a composite energy store for each of a plurality of service provider communications networks (service provider network 1 1580, service provider network 2 1582, service provider network 3 1584, . . . , service provider network M 1586).

Control device 1000 includes a processor 1002, e.g., a CPU, a network interface 1004, e.g., a wired or optical interface, an input device 1006, e.g., a keyboard and/or mouse, an output device 1008, e.g., a display, an assembly of hardware components 1010, e.g., and assembly circuits and memory 1012 coupled together via a bus 1014 over which the various elements may interchange data and information.

Memory 1012 includes a control routine 1020, an assembly components 1022, e.g. an assembly of software components, e.g., modules, routines, sub-routines, applications, etc. and data/information 1024. Control routine 1020 includes instructions which when executed by processor 1002 control the control device 1000 to implement basic operational functions, e.g., read memory, write to memory, control an interface, load a program, subroutine, or app, etc. Assembly of components 1022, e.g., an assembly of software components, e.g., routines, subroutines, applications, etc., includes, e.g., code, e.g., machine executable instructions, which when executed by processor 1002, controls the control device 1000 to implement steps of a method, e.g., steps of a method which are performed by a control device described with respect to any of the Figures.

Data/information 1024 includes received networks; information 1026, received user devices' information 1028, generated service bubble information 1030, generated updated service bubble information 1032, and new data available flags.

Received networks information 1026 includes initial information 1036 and updated information. Exemplary received networks' information 1026 includes service provider network information corresponding to a plurality of service provider networks, e.g., service provider network 1 information, . . . , service provider network M information. The information can include information about whether the network uses green energy and may include a green energy score and/or information indicating the energy sources or mixes of energy sources used to power the network (e.g., portion of network power provided by wind, solar, gas, coal and/or nuclear).

Received user devices' information 1028 includes initial information 1040 and updated information 1042. Exemplary received user devices' information 1028 includes information corresponding to a plurality of user devices, e.g., user device 1 information, . . . , user device N information. Individual user devices can report measured energy usage along with information about the network or networks the device was connected to and communicating with at the time the energy usage was measured. The reported information from a UE can include an energy score generated by the UE or the actual used power which was measured, e.g., in milliwatts.

Generated service bubble information 1030 includes service bubble information corresponding to a plurality of user devices (UE 1 service bubble information 1044, . . . , UE N service bubble information 1046. Exemplary UE 1 service bubble information 1044 includes, e.g., UE device 1 criteria to network matching information which includes sets of matching information for a plurality of different geographic areas, said matching information used to determine which network is to be used by UE 1. This can include power related information and/or which control logic is to be given priority when making a network selection decision, e.g., application layer logic or lower level logic. Exemplary UE N service bubble information 1046 includes, e.g., UE device N criteria to network matching information 1332 which includes sets of matching information for a plurality of different geographic areas, said matching information used to determine which network is to be used by UE N.

Generated updated service bubble information 1032 includes updated service bubble information corresponding to one or more user devices (updated UE 1 service bubble information 1048, . . . , updated UE N service bubble information 1050). Different service bubbles may be, and sometimes are, updated at different times.

New data available flags 1034 includes new data flags for each of the user devices (UE 1 flag 1052, . . . , UE N flag 1054). A new data available flag indicates, e.g., by being set to a value of 1, that an updated service bubble, corresponding to the UE, has been generated and is available to be uploaded by the UE. In some embodiments, after the updated service bubble has been successfully uploaded into the UE, the flag is cleared, e.g., set to a value of 0.

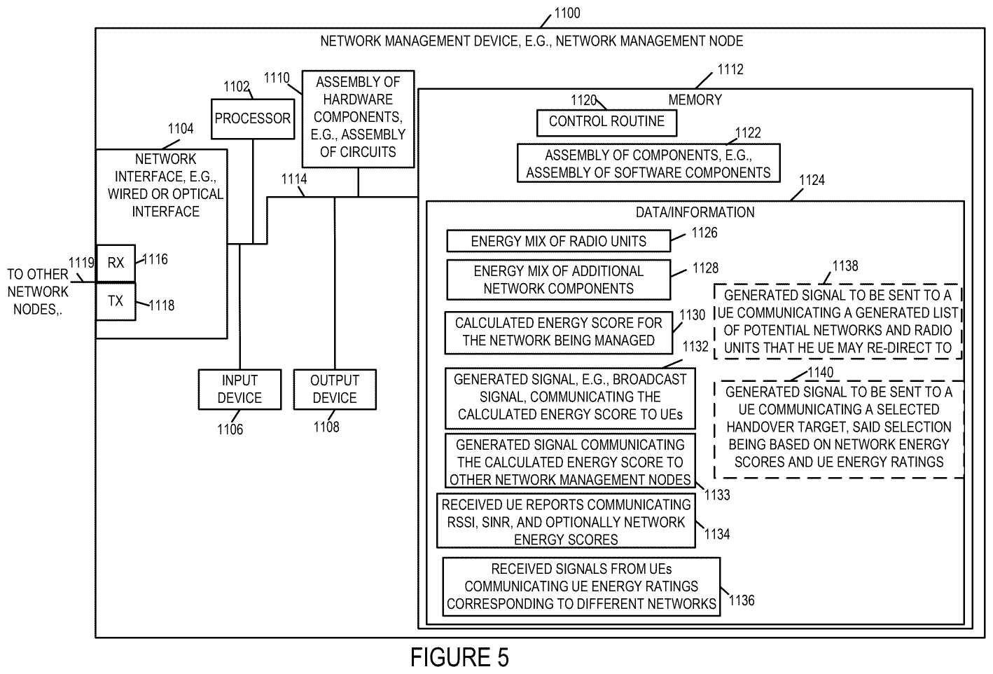

FIG. 5 is a drawing of an exemplary network management device 1100, e.g., a network management nod, in accordance with an exemplary embodiment which, collects power consumption information and/or power scores generated by UEs, generates power scores or other network related information from information received from networks and/or UEs and which sends information including profiles to base stations for communication to wireless devices, e.g., UEs. The network management device 1100 can be, and sometimes is, also involved in handoff decisions and can communicate to a wireless device a handoff command and/or handoff information which may be mandatory or recommended. Along with the handoff command can be an indicator indicating whether it is mandatory or optional and power related information can be provided and sometime is provided with the handoff information to facilitate wireless device network selection by providing information allowing a UE to make an informed decision with regard to energy consumption and/or whether the network base station which is the target of the handoff is considered sufficiently “green” from an energy policy perspective.

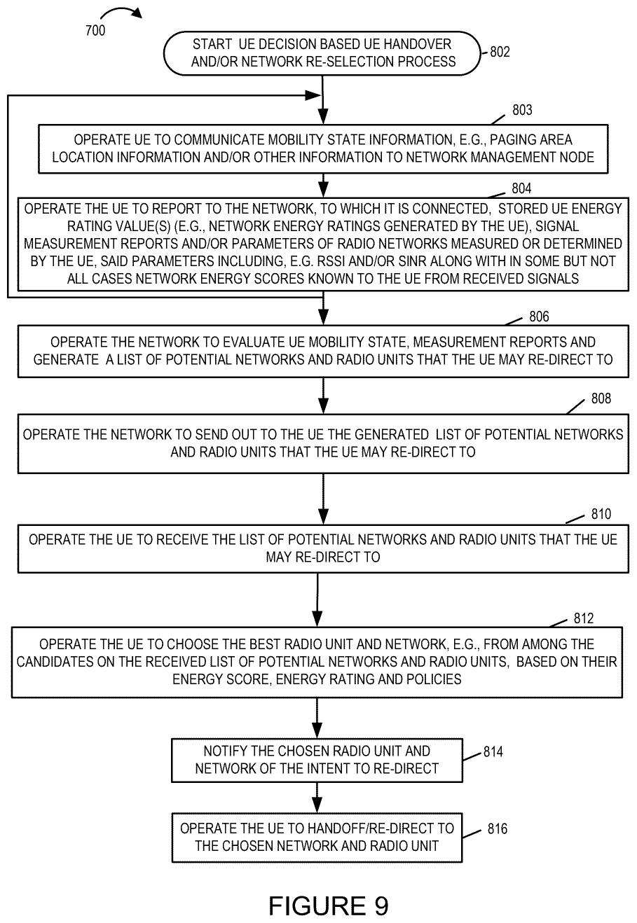

Network management device 1100 is, e.g., any of network 1 management node 1516, network 2 management node 1522, network 3 management node 1528 or network M management node 1532 of FIG. 1 or FIG. 2, or a network management node implementing steps of method of flowchart 400 of FIG. 6, a network management device implementing steps of the method of flowchart 600 of FIG. 8, a network management device implementing steps of the method of flowchart 700 of FIG. 9 and/or a network management device described with respect to any of the Figures.

Network management device 1100 includes a processor 1102, e.g., a CPU, a network interface 1104, e.g., a wired or optical interface, an input device 1106, e.g., a keyboard and/or mouse, an output device 1108, e.g., a display, an assembly of hardware components 1110, e.g., and assembly circuits and memory 1112 coupled together via a bus 1114 over which the various elements may interchange data and information.

Memory 1112 includes a control routine 1120, an assembly of components 1122, e.g. an assembly of software components, e.g., modules, routines, sub-routines, applications, etc. and data/information 1124. Control routine 1120 includes instructions which when executed by processor 1102 control the network management device 1100 to implement basic operational functions, e.g., read memory, write to memory, control an interface, load a program, subroutine, or app, etc. Assembly of components 1122, e.g., an assembly of software components, e.g., routines, subroutines, applications, etc., includes, e.g., code, e.g., machine executable instructions, which when executed by processor 1102, controls the network management device 1100 to implement steps of a method, e.g., steps of a method which are performed by a network management device described with respect to any of the Figures.

Data/information 1124 includes information 1126 indicating an energy mix of radio units, information 1128 indicating an energy mix of additional network components, a calculated energy score 1130 for the network being managed by the network management node 1100, a generated signal 1132, e.g., a broadcast signal, communicating the calculated energy score for the network to UEs, a generated signal 1133 communicating the calculated energy score for the network to other network management node, received UE reports 1134 communicating RSSI, SINR, and optionally, network energy scores, and received signals 1136 from UEs communicating UE energy ratings corresponding to different networks. Data/information 1124, in some embodiments, further includes a generated signal 1138 to be sent to a UE, said signal communicating a generated list of potential networks and radio units that the UE may re-direct to, e.g., as part of implementing a UE decision based UE handover/network re-selection method, based on network energy scores and UE energy ratings (see FIG. 9). Data/information 1124, in some embodiments, further includes a generated signal 1140 to be sent to a UE, said signal communicating a selected handover target, e.g., a network management node 1100 selected target network from among a plurality of alternative service provider networks, that the UE is being directed to use, e.g., as part of implementing a network decision based UE handover/network re-selection method, based on network energy scores and UE energy ratings (see FIG. 8).

In some embodiments, features relate to Optimization of Dual Steer network selection, e.g., with regard to taking into consideration energy efficiency (EE). For selection of the additional network during Dual Steer operation on the SUPI used for selecting the additional network, in some embodiments special criteria, e.g. including energy efficiency consideration will be taken into account to optimize the selection.

One of the criteria is geo-location. Geo-location is, in some embodiments, used as one of the criteria to select the additional network. Specially for PNI-NPN+PLMN scenario—e.g., for SUPI configured to connect only our CBRS network due to non-nationwide small-cell nature of our CBRS network deployment. Connecting to small cells in a CBRS network, as opposed to connecting to larger cells in another service provider network, can, and in some embodiments, does improve energy efficiency, e.g., as the energy levels needed to support wireless communications for the small CBRS cells may be lower than the energy levels needed to support the large cell wireless communications, e.g., for the same amount of data being communicated. The improved logic in some embodiments is oriented to provide specific traffic policies/criteria (Aggregate Maximum Bit Rate (AMBR), Quality of Service (QoS), etc.) to Spectrum Business customers in pre-defined locations.

In some embodiments, an enhancement to Equivalent Home Public Land Mobile Network (EHPLMN) list is implemented with additional criteria per subscriber/profile (in contrast to simply selecting between equivalent PLMNs (Public Land Mobile Networks) on a list based on order on the order in which they appear on the list) so that the UE can select dynamically (rather than statically as of now) a more optimized network available. The additional selection criteria can, and in some embodiments, do direct the UE to a more energy efficient network.

In some embodiments, for supporting opportunistic offload, for a profile for a subscriber, additional criteria is included for an enhanced EHPLMN (Equivalent Home Public Land Mobile Network) list for that subscriber, which controls network selection criteria per subscriber independently on a set of different networks. The network selection criteria for a subscriber depends on one, more than one, or all of the following: i) UE characteristics like battery, screen size, mobility state, capabilities etc., ii) Flags part of the SIBs (System Information Blocks) indicating RAT, resources broadcasted, band, energy efficient flags, green network indication, etc. iii) Measurements—RSRP, RSRQ, RSSNR/SINR etc., iv) Location dependent information—Neighbor cells indicated, load balancing indications (may be an indicator that network can share with the UE—not currently available but would help make a more collaborative decisions without solely relying on network policy, v) historical data, usage, slicing, service availability etc. may be considered.

In roaming scenarios cost factor is taken into consideration where networks with a zero-dollar roaming agreement (no extra cost for roaming) are preferred in some cases.

Prioritization amongst networks, e.g., EHPLMNs, performed in a UE device or network device as part of a network selection or attachment decision process, is based in some embodiments on one, more than one, or all of: i) energy efficiency level (advertised by the network), ii) energy efficiency score (captured and stored in the UE from historical interactions or config push), iii) Green energy level, e.g., whether the network is utilizing green power or not, iv) type of usage (potentially), and then a search for other EHPLMNs that are available is performed, to ensure that the selected network, which we are connecting to, is the most optimal EHPLMN from the list.

In some embodiments an operator, e.g., network service provider, transmits, e.g., from a base station in its network, to a wireless device, e.g., a UE, e.g., adds or pushes, a flag, used in network selection control, that indicates that for a particular SUPI (Subscription Permanent Identifier), e.g., corresponding to a UE, an HPLMN (Home public land mobile network) should be skipped during search, network selection and re-selection. Meaning not searched for or selected (which by default the UE tries to select) for HPLMN+VPLMN (where BPLMN=Visiting Public Land Mobile Network) scenarios. e.g., for SUPI always connecting/roaming to Verizon network. In this context a SUPI is a 5G globally unique Subscription Permanent Identifier (SUPI) allocated to a subscriber.

In some embodiments thresholds and/or criteria are set for wireless device selection of a particular CBRS network or particular MVNO partner network (e.g., Verizon network), the network selection logic takes place in some cases at the higher application level, e.g., on a Google/Apple logic layer. In some embodiments, standards, e.g., for PLMN selection procedures in 3GPP, includes features of the present invention. The optimization, in some cases includes switching between the upper layer logic or the lower layers ones with regard to SIM/SUPI. In some embodiments network selection information, e.g., network control logic selection information, which is sometimes in the form of a flag, is set and communicated to a wireless device, e.g., UE, to indicate to the device to which it is sent a hierarchy between the logic at the application level (current algorithms from Google/Apple) and the optimized DS network selection logic. In this way, which logic layer or application which will determine the network selection outcome can be changed by altering the flag value transmitted to one or more wireless devices. The flag, e.g., network selection logic priority indicator, in some embodiments, is based on conditions rather than a priority. In such a case the conditions can be based on the quality of user experience which is determined in real time or a particular condition indicative of the quality of the user experience. Switching between user selection options/logic can also be specified by the flag or by another signal sent to a wireless device with the switching depending on one or more of: Quality of Experience (QoE) thresholds, where the thresholds may correspond to network stability or some other value with potentially different thresholds or selection logic being specified for different geographic locations.

Energy Efficiency aspects of network selection sometimes involve monitoring power consumption at the UE and generating a Power Consumption Score at the UE. The power consumption score and/or used power per unit of time are, in some embodiments, communicated to the network, e.g., a server in the network, along with information indicating the network or networks that were being used when the power use measurement/consumption score was generated by the reporting device.

In some embodiments a wireless device, using one or more networks, generates a power consumption score based on measurement made by the device of the energy consumption when using the network or networks. The energy measurement may be, and sometimes is, a measure of the battery power consumed at the device during a measurement time period and may be expressed in milli-watts. This is an actual per network power usage measurement in the case where a device is communicating with one network at a time. The UE device can, and sometime does, use machine learning techniques and measured power consumption information to learn from statistical information gathered which using networks to which the device was connected which network is likely to provide the best power efficiency at a given time and can then select a network based on the one which is likely to require the least UE device power to support the intended communication to be preformed by the UE.

A UE device uses the power consumption score or other power consumption information to select which network to use, e.g., in a given geographic location. The power consumption information/score is used alone or, potentially with other criteria, to select a network to use at a given time. The power consumption score(s) can be, and sometimes is, used for network selection based on operator policy.

In various embodiments real-time power consumption measurements are captured in a wireless device UE and used in the UE device as well as being communicated to a network device in some embodiments. Measured power consumption information is associated with one or more of: a communications band, usage information (e.g., amount of data transmitted and/or received), a channel quality indicator (CQI), a Radio Access Technology (RAT). The power consumption score can be a function of the measured power consumption during a period of time and one or more of the other pieces of associated information. The score can be calculated by comparing against a baseline consumption model for the location, band, usage, and RAT. The power consumption score can be locally generated in the UE device based on its measurements and/or generated in the communications network, e.g., at a server based on information provided by multiple UEs based on power consumption and related information reported with regard to the devices operation when at a given geographic location to which the power consumption score corresponds. In the case of a network provided power consumption score, the UE device can request the score, and it can be downloaded to the device, or it can be broadcast/advertised by a base station through which the network to which the score corresponds can be accessed.

The score can, and in some embodiments is, utilized to make cell selection or cell reselection decisions and/or in deciding how to respond to receipt of handover commands, in cases, where multiple network options are available. Handover commands/instructions communicated to a wireless device, e.g., via a wireless connection, can be, and sometimes are, flagged, e.g., indicated, to be mandatory or optional from the network. In the case of optional handover commands/instructions the score along with other parameters such as battery level, usage, service type, etc. corresponding to a network to which the handover is to be completed (e.g., target base station or network) can be utilized in a decision making process implemented by the wireless device considering the handover, e.g., in a weighted decision making g process, on whether to accept the handover command or deny with or without suggestion of which network/cell site the user device may like to be handed over to.

In some embodiments information communicated to a wireless device, e.g., UE device, includes a threshold from the network operator that limits the amount and/or type of data offload that the device can use once registered in the target network (additional network). The limit can be, and sometimes is, based on the energy characteristics of the target network (if known). The allows a network operator to take into account not only the current congestion (energy efficiency might be low) or potential energy efficiency/savings of the target network, but then also force the device to offload only a type of data or amount of data once registered with the selected network and data offload continues.

In many existing systems, EHPLMNs are all selected from the list stored in the wireless device for purposes of selecting a network in the order that they appear in the list, and once connected to an EHPLMN, the wireless device, e.g., UE does not search for another PLMN while the device remains successfully connected.

In various embodiments rather than selecting an EHPLMN simply on the order in which it appears in a list, prioritization amongst EHPLMNs is based on one or more or all of the following: i) energy efficiency level information (advertised by the networks), ii) energy efficiency scores corresponding to the networks (advertised by the networks), iii) power consumption scores generated based on information measured and optionally reported by one or more UEs (captured and stored in the UE from historical interactions or config push), iv) a Green energy level indicator communicated from each of the networks, e.g., an indicator indicating whether the network is utilizing green power (such as wind or solar) or not, and v) type of usage (potentially). After network selection and connection the device, e.g., the UE, may, and sometimes does, search, e.g., a periodic intervals or at some other points in time, while still successful connected to the initially selected network, for other EHPLMNs that are available to ensure that the device is connecting to the most optimal EHPLMN from the list at any point in time and/or as the device moves from one geographic location to another without losing connectivity to the network.

Various features relate to improving hand it/out procedures. This can save energy as well as avoid ping-pong situations and potentially reduce the need for additional network scanning. By improving network selection/re-selection procedures for a network we improve the hand in/out procedures into/out of our network or partner networks. This improves energy consumption, QoE, packet loss, battery consumption.

Fine tuning band characteristics involves, in one embodiment, for different bands, having different operator policies. This band related information is included in the profiles downloaded to the UE in some, but not necessarily all, embodiments. The information can include different thresholds, used in network selection, for different bands. Different partners can be operating in different bands, and in some embodiments, the profile has different policies/settings depending on the band and the partner to which a network decision relates, including one, more than one, all or any combination or possible sub-combinations of the following:
i. Policies for data path switching is consolidated in one place in some embodiments, breaking dependency from upper layers such as Google/Apple logic layers.
ii. Different profiles can be used for different transition times and/or requirements.
iii. Network selection thresholds can be, and sometimes are, optimized dynamically to make the UE behavior green. In some embodiments networks which use Rich Communication Services (RCS) messaging which tends to be more energy efficient over SMS messaging are prioritized and selected over non-RCS networks (e.g., networks which use SMS (Short Message Service) messaging.
iv. Services being tagged with a green rating and prioritized based on whether a service is green enough or not.

FIG. 6 is a drawing of a flowchart 400 an exemplary method of calculating a composite energy score for a service provider network, communicating the calculated network energy score to radio units in base stations of the network, and operating the radio units to communicate, e.g. broadcast, the network energy score to UEs. The energy score for a service provider network may be calculated by an operations support system (OSS), e.g., a network management node, which is part of the OSS or by a control device, e.g., server implementing a dedicated network function (NF) for Energy Efficiency (EE) analysis and policies, which is, e.g., part of core network functionality.

Flowchart 400 will be described with respect to an exemplary embodiment, in which the energy scores for the networks are calculated by the network management nodes (1516, 1522, 1528, 1532); however, in some other embodiments, the energy scores are calculated by another device(s), e.g. by EE policy and analysis function nodes (1590, 1592, 1594, 1596) or by a control device 1502 supporting multiple networks, which may perform EE analysis, include EE policies, and send to the calculated energy scores for the network to the network management node of the network or to the access devices, e.g. base stations, of the network to be transmitted by the RUs of the network. An energy score will be calculated, e.g., by each network's network management node (1516, 1522, 1528, 1532), for each of a plurality of networks (service provider network 1 1580, service provider network 2 1582, service provider network 3 1584, service provider network M 1586), and communicated, e.g., broadcasted, to UEs and, in some embodiments communicated to other network management nodes. Operation of the exemplary method starts in step 402 and proceeds to step 408. In step 408 a network management node, e.g. network 1 management node 1516, calculates a composite energy score for the network, e.g., service provider network 1 1580, based on an energy mix 404 of radio units in the network and an energy mix 406 of the network. Energy mix of radio units (RU) 404 includes information regarding: i) type of energy, e.g., coal, natural gas, oil, nuclear, solar, wind, geo-thermal, etc., that is powering up the RUs, ii) performance of the energy type that is powering up the RUs, iii) energy characteristics of the energy type being used to power up the RUs, iv) power saving technologies, e.g., energy efficiency (EE) features offered by the service provider operator of the network to subscribers, being employed in the RUs. In some embodiments, energy mix of the network 406 includes information regarding: i) type of energy, e.g., coal, natural gas, oil, nuclear, solar, wind, geo-thermal, etc., that is powering up the overall network, which includes both RUs and non-RU entities such as baseband units (BBU) including distributed units (DUs) and central units (CUs) of base stations, core network nodes, network management nodes, control devices, backhaul entities, e.g. routers, in the network ii) performance of the energy type(s) that are powering up the network, iii) energy characteristics of the energy type(s) being used to power up the network, iv) power saving technologies, e.g., energy efficiency (EE) features offered by the service provider operator of the network to subscribers, being employed in the network. In some embodiments, energy mix of the network 406 includes information regarding: i) type of energy, e.g., coal, natural gas, oil, nuclear, solar, wind, geo-thermal, etc., that is powering up non-RU entities such as baseband units (BBU) including distributed units (DUs) and central units (CUs) of base stations, core network nodes, network management nodes, control devices, backhaul entities, e.g. routers, in the network ii) performance of the energy type(s) that are powering up the non-RU entities in the network, iii) energy characteristics of the energy type(s) being used to power up the non-RU entities in the network, iv) power saving technologies, e.g., energy efficiency (EE) features offered by the service provider operator of the network to subscribers, being employed in the non-RU entities in the network. In some embodiments, the energy mix of the network 408 further includes energy information related to 3rd party entities, e.g., cloud services, data aggregators, etc. being used by the network. Step 408 is repeated on a recurring basis and/or in response to a detected change in either of the energy mix of radio units or the energy mix of the network. Operation proceeds from step 408 to step 410.

In step 410 the network management node, e.g., network 1 management node 1516 for the network, e.g., service provider network 1 1580, communicates the calculated energy score for the network to the base stations of the network, e.g., to: network 1 access device 1 1510, network 1 access device 2 1512 and network 1 access device N1 1514. In step 412 each of the base stations, e.g., each of the baseband units of the base stations (e.g., base stations 1510, 1512, 1514), of the network, e.g., network 1 1580, incorporates the energy score for the network into a set of information to be communicated, e.g., broadcasted, by the radio units (RU1 15101, RU2 15121, RU3 15141 of the base stations (1510, 1512, 1514), respectively, to UEs. Operation proceeds from step 412 to step 414. In step 414, which is performed by each base station in the network, the radio unit of the base station is operated to communicate the energy score for the network to one or more UEs. Step 414 includes one or both of steps 416 and 418. In step 416 the radio unit of the base station is operated to broadcast the energy score for the network to UEs. In step 416 the radio unit of the base station is operated to communicate, e.g., send in a downlink message, the energy score for the network to a UE, e.g., in response to a received request for an energy score from the UE. Step 414 is performed repetitively, e.g., on a recurring basis.

In some embodiments, optional step 420 includes, and operation also proceeds from step 408 to step 420. In step 420 the network management node, e.g., network 1 management node 1516, of the network, e.g., service provider network 1 1580, is operated to communicate the energy score for the network, e.g., service provider network 1 1580, to network management nodes of other networks, e.g., to network 2 management node 1522 of service provider network 2 1582, to network 3 management node 1528 of service provider network 3 1584 and to network M management node 1532 of service provider network M 1586.

Operation proceeds from step 414 to step 425, in which the network management node, e.g., network 1 network management node 1516, is operated to support UE handover and/or network re-selection operations, e.g., by performing network management device operations of any of FIGS. 8 and 9.

It should be appreciated that the method of flowchart 400 of FIG. 4 is performed by each of the network management nodes (network 1 management node 1516, network 2 management node 1522, network 3 management node 1528, . . . network M management node 1532) in system 1500, e.g., with each network management node generating a network energy score value corresponding to its own network, and then communicating the generated network energy score value to UEs within its coverage areas, via its access points, e.g., base stations, and optionally communicating the generated network energy score value to other network management nodes of other alternative networks.

The updating of network energy scores is performed in accordance with a network operator's policies. It may be dynamically changed or permanent depending upon the operator's policies. In some embodiments, when a service provider operator deploys new EE services, the network energy scores will be analyzed and re-calculated more often than in an environment when services remain static. In some embodiments, a service provider operator, sets a timer, and recalculates a new network energy score, when the timer expires, e.g. in accordance with a predetermined schedule.

FIG. 7, comprising the combination of FIG. 7A, FIG. 7B and FIG. 7C, is a flowchart 500, comprising the combination of Part A 501, Part B 503 and Part C 505, of an exemplary method of operating a UE, e.g., UE 9 1556, in accordance with an exemplary embodiment. Operation proceeds from start step 502 to step 504, in which the UE is operated to turn on. Operation proceeds from step 504 to step 506.

In step 506 the UE is operated to search, e.g. monitor, for available networks. Step 506 includes step 508, in which the UE is operated to receive signals, e.g. broadcast signals, said received signals communicating reference signals and network information, from each of the available networks. Operation proceeds from step 506 to step 509.

In step 509 is UE is operated to determine, from received signals, information corresponding to detected networks. Step 509 includes steps 510 and 512. In step 510 the UE is operated to measure the received reference signals to determine network signal strength information, e.g. Received Signal Strength Indicator (RSSI), Signal-to-Noise-plus-Noise Ratio (SINR), etc., corresponding to each of the available networks. Operation proceeds from step 510 to step 512.

In step 512 the UE is operated to recover, from received signals, communicated network information, e.g., network identifier and/or radio unit identifier information along with energy score information, e.g., determine a network identifier and/or a radio unit identifier, and a corresponding network energy score for each of the available networks. Step 512 includes step 514, in which the UE is operated to receive and recover a network energy score transmitted, e.g., broadcasted, from a radio unit corresponding to each available network. Operation proceeds from step 512 to step 516.

In step 516 the UE is operated to establish network selection criteria, e.g., based on RSSI and SINR criteria. Operation proceeds from step 516 to step 518. In step 518 the UE is operated to identify the available networks, which have satisfied the network selection criteria. The network selection criteria is, e.g., 3GPP PLMN selection criteria for cellular or other non-3GPP access technologies or carrier defined selection criteria/threshold. Operation proceeds from step 518 to step 520.

In step 520 the UE is operated to obtain, e.g., from UE energy rating database 519, if available, a UE stored energy rating for each of the identified available networks, which have satisfied the network selection criteria. Operation proceeds from step 520 to step 522.

In step 522 the UE is operated to select, network from among the available networks which have satisfied the selection criteria and a radio unit (e.g., a radio unit which is part of a cellular base station or part of a WiFi AP in the selected network) based on the network energy scores corresponding to the networks from which the selection is made, the obtained stored UE energy rating corresponding to the networks from which the selection is made and/or a network selection policy, e.g., a network operator policy for maximized performance or energy savings. Operation proceeds from step 522 to step 524.

In step 524 the UE is operated to connect to the identified radio unit and network. Operation proceeds from step 524, via connecting node A 526, to step 527.

In step 527 the UE is operated to measure device usage, e.g., data, during a monitoring period of time, e.g., measure data transmitted to and/or received from a communications network to which the UE is connected. Operation proceeds from step 527 to step 528.

In step 528 the UE is operated to measure power consumption on the UE for the monitoring period, e.g., power consumed for communication via the network to which the UE is connected, said power consumption measurement producing a consumed power measurement value. Operation proceeds from step 528 to step 529.

In step 529 the UE is operated to generate one or more usage statistics, e.g., based on measured data usage, corresponding to the monitoring period. One exemplary usage statistic is battery discharge while not charging. Another exemplary usage statistic is a measurement of battery discharge, while charging, taking into account the energy being added from the energy source. Operation proceeds from step 529 to step 530.

In step 530 the UE is operated to calculate, based on one or more device usage statistics and a power consumption measurement value of power consumption on the UE, a current UE energy rating for the network, to which the UE is connected and optionally on network power source information. Operation proceeds from step 530 to step 532.

In step 532 the UE determines if a UE energy rating for this network, to which the UE is connected, already exists in the UE, e.g., already exists in UE energy rating database 519 in the UE. If the determination of step 532 is that the energy rating for this network, to which the UE is currently connected, does not already exist in the UE, then operation proceeds from step 532 to step 536. In step 536 the UE is operated to store the current UE energy rating for the network, as a new entry in a set of information, e.g., in UE energy rating database 519, which includes energy ratings for one or more different networks, in the UE. UE energy rating database 519 includes a network 1 (NW1) identifier 5191 and a corresponding network 1 UE energy rating (NW UE ER) 5192. UE energy rating database 519 may, and sometimes does, include additional sets of information corresponding to different networks, to which the UE has been connected. For example, UE energy rating database includes a network M identifier 5193 and a corresponding network M UE energy rating (NW M UE ER) 5194. Operation proceeds from step 536 to connecting node B 5421.

Alternatively, if the determination of step 532 is that the energy rating for this network, to which the UE is currently connected, does already exist in the UE, then operation proceeds from step 532 to step 534. In step 534 the UE is operated to compare the calculated current UE energy rating for the network to a stored UE energy rating for the network. Operation proceeds from step 534 to step 538. In step 538, the UE determines, based on the comparison of step 534, if the calculated current UE energy rating for the network is different from the stored UE energy rating for the network by at least a set threshold amount. If the determination of step 538 is that the calculated current UE energy rating for the network is different from the stored UE energy rating for the network by at least a set threshold amount, then operation proceeds from step 538 to step 540. In step 540 the UE stores the current calculated UE energy rating for the network to update the UE energy rating for the network, e.g., replace the stored UE energy rating for the network with current calculated UE energy rating for the network. Operation proceeds from step 540 to step 542, in which the UE communicates the UE calculated energy rating to a device in the communications network. Operation proceeds from step 542 to connecting node B 5421.

Alternatively, if the determination of step 538 is that the calculated current UE energy rating for the network is not different from the stored UE energy rating for the network by at least the set threshold amount, then the UE energy rating database is not updated and operation proceeds from step 538 to step connecting node B 5421

Operation proceeds from connecting node B 5421 to step 527, in which the UE measures device usage during another monitoring period. Operation also proceeds from connecting node B 5421 to step 543, in which the UE is operated to participate in a network energy rating base handover and/or network re-selection process, e.g., the UE perform UE steps of FIG. 8 or FIG. 9.

Operation also proceeds from connecting node B 5421, via connecting node C 5422, to step 544. In step 544 the UE is operated to determines whether or not to perform an energy saving operation at the UE based on: i) the current network energy score corresponding to the network, ii) the current UE energy rating for the network to which the UE is currently connected, iii) a remaining energy storage level in the UE; and iv) policy. Step 544 is performed repetitively on an ongoing basis.

Step 544 may, and sometimes does, include step 546, in which the UE decides to perform an energy saving operation at the UE based on: a detected change in the network energy score, e.g., indicating a lower renewable energy supply percentage, a detected change in the UE energy rating for the network, e.g., indicating a higher energy usage rate at the UE, or a detected energy storage level, e.g., battery energy level, in the UE going below a threshold level. Operation proceeds from step 546 to step 548.

In step 548 the UE is operated to implement an energy saving operation at the UE. Step 548 includes one or more of: steps 550, 552, 554, 556, 558 and 560. In step 550 the UE reduces power to the UE display, e.g., the UE lowers the display intensity to save power. In step 552, the UE changes the inactivity time setting to cause shutdown or screen blackout more frequently to save power. In step 554 the UE reduces or limits the UE data rate to save power. In step 556 the UE increase sleep time intervals, e.g., changes DRX cycles, to save power. In step 558 the UE switches from a 5G cellular operation with a guaranteed bit rate to a WiFi operation with best effort traffic to save power. In step 560 the UE turns-off non-essential circuits in the UE, e.g., shuts down the GPS receiver, turns-off camera, etc., to save power. Operation proceeds from step 548 back to the input of step 544.

FIG. 8 is flowchart 600 of an exemplary method of operating a communications system to perform a network decision based UE handover and/or network re-selection method in accordance with an exemplary embodiment. Operation of the exemplary method starts in step 602 and proceeds to step 604. In step 604 a UE, e.g., UE 1556, is operated to report to the network to which it is connected, e.g., to network 1 1580, parameters of radio networks detected by the UE, e.g., a network identifier and corresponding signal strength measurements, e.g., RSSI and/or SINR, made by the UE, and in some embodiments, stored UE energy ratings corresponding to at least some of the detected network and/or received energy scores corresponding to at least some of the detected networks. Operation proceeds from step 604 to step 605.

In step 605 the network management node, e.g., network 1 management node 1516, is operated to receive UE reported information including the reported parameters such as UE network energy ratings and/or reported network energy scores. Operation proceeds from step 605 to step 606.

In step 606 the network management node, e.g., node 1516, is operated to select a handover target, e.g., communications network and radio unit, for the UE based on one, more than one, all or any sub-combination of: network evaluation of UE mobility state, ii) received UE measurement reports, iii) energy rating of communications networks, iv) network energy scores, v) received parameters of radio network provided by the UE, vi) signal measurements mad by the UE and/or vii) set network policies. Operation proceeds from step 606 to step 608.

In step 608 the network management node, e.g. node 1516, is operated to generate a handover message indicating a network selected communications network and radio unit to be used by the UE as a handover target. Operation proceeds from step 608 to step 610.

In step 610 the network management node, e.g. node 1516 is operated to communicate the handover message to the UE. Operation proceeds from step 610 to step 612. In step 612 the UE is operated to receive the handover message re-directing the UE to a network selected network and radio unit, e.g., the handover target (e.g., communications network identified by a PLMID and a base station identifier, identifying a radio unit in the communications network to be used as a handover target). Operation proceeds from step 612 to step 614, in which the UE, e.g., UE 1556, is operated to move (e.g., implement and complete a handover/move to the communications network and radio unit) to the network selected network and radio unit (e.g., by completing a handover to the base station corresponding to the radio unit of the communications network indicated in the handover message as the handover target).

FIG. 9 is flowchart 700 of an exemplary method of operating a communications system to perform a UE decision based UE handover and/or network re-selection method in accordance with an exemplary embodiment. Operation of the exemplary method starts in step 802 and proceeds to step 803.

In step 803, a UE, e.g., UE 9 1556, is operated to communicate mobility state information, e.g., paging area location information, and/or other information to a network management node. Operation proceeds from step 803 to step 804. In step 804 the UE is operate to report to the network, e.g. network 1 1580, to which it is connected, stored UE energy rating value(s), e.g., network energy rating values generated by the UE, signal measurement reports, and/or parameters of radio networks measured or determined by the UE, said parameters including, e.g., RSSI and/or SINR, along with, in some, but not all cases, network energy scores know to the UE from received signals. Steps 803 and 804 and performed repetitively, e.g., on an ongoing basis while the UE is connected to the network. Operation proceeds from step 804 to step 806.

In step 806 the network management node, e.g. node 1516, is operated to evaluate UE mobility state, measurement reports and generate a list of potential networks and/or radio units that the UE may re-direct to. Operation proceeds from step 806 to step 808. In step 806 the network management node is operated to send out to the UE, the generated list of potential networks and radio units that the UE may re-direct to. Operation proceeds from step 810 to step 812.

In step 812 the UE chooses the best radio unit and network, e.g. from among the candidates on the received list of potential networks and radio units, based on the energy score, energy rating and policies. Operation proceeds from step 812 to step 814. In step 814 the UE notifies the chosen radio unit and network of the intent to re-direct. Operation proceeds from step 814 to step 816. In step 816 the UE is operated to handoff/re-direct to the chosen network and radio unit.

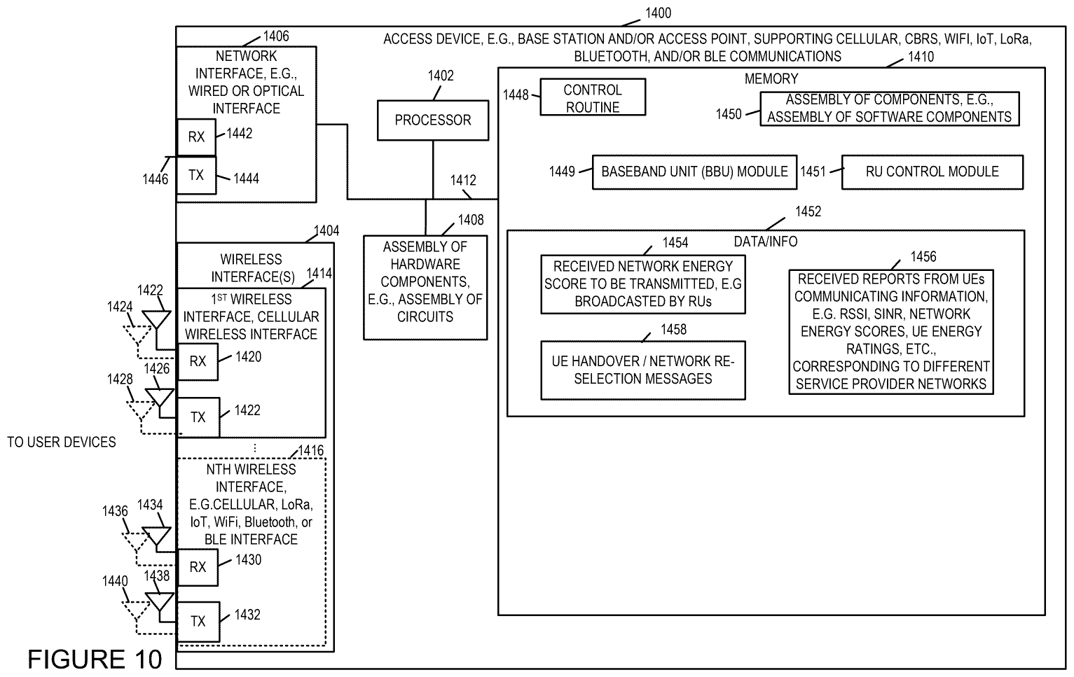

FIG. 10 is a drawing of an exemplary access device 1400, e.g., a base station and/or an access point (AP), supporting cellular. CBRS, WiFi, IoT, LoRa, Bluetooth, and/or BLE communications, in accordance with an exemplary embodiment. Exemplary access device 1400 is, e.g., any of the network access devices (1510, 1512, 1514, 1518, 1520, 1524, 1526, 1530) of system 1500 of FIG. 1 and FIG. 2. Exemplary access device 1400 includes a processor 1402, e.g., a CPU, wireless interfaces 1404, network interface 1406, assembly of hardware components 1408, e.g., an assembly of circuits, and memory 1410 coupled together via a bus 1412 over which the various elements may interchange data and information.

Wireless interfaces 1404 includes one or more wireless interfaces (1st wireless interface 1414, . . . , Nth wireless interface 1416). In some embodiments, each of the wireless interfaces (1414, . . . , 1416) is referred to as a radio unit (RU). One or more of the wireless interfaces included in wireless interfaces 1404 are cellular wireless interfaces. In some embodiments, different wireless interfaces included in wireless interfaces 1404 may correspond to different frequency bands, different communications protocols and/or different communications technologies. 1st wireless interface 1414 includes wireless receiver 1418 and wireless transmitter 1420. Wireless receiver 1418 is coupled to one or more antennas or antennas elements (1422, . . . , 1424) via which the access device 1400 receives wireless signals, e.g., cellular wireless signal, from end user devices. Wireless transmitter 1420 is coupled to one or more antennas or antennas elements (1426, . . . , 1428) via which the access device 1400 transmits wireless signals to end user devices. Nth wireless interface 1416 includes wireless receiver 1430 and wireless transmitter 1432. Wireless receiver 1430 is coupled to one or more antennas or antennas elements (1434, . . . , 1436) via which access device 1400 receives wireless signals from end user devices. Wireless transmitter 1432 is coupled to one or more antennas or antennas elements (1438, . . . , 1440) via which the access device 1400 transmits wireless signals to end user devices.

Network interface 1406, e.g., a wired or optical interface, includes receiver 1442, transmitter 1444 and connector 1446 coupled together. Network interface 1406 couples the access device 1400 to other network devices, e.g., OSS devices including network management nodes, control devices, core network nodes including, e.g., an EE analysis and policy function node, other access devices, e.g. other base stations, and/or access points, backhaul network devices, e.g. routers, etc. and/or the Internet.

Memory 1410 includes control routine 1448, a baseband unit (BBU) module 1449 including base station CU/DU functionality, a radio unit (RU) control module for controlling the radio units, e.g., the wireless interface modules (1414, . . . , 1416) in access device 1400, and assembly of components 1450, e.g., an assembly of software components, and data/information 1452. Control routine 1448 includes instructions which when executed by processor 1402 control the access point 1400 to implement basic operational functions, e.g., read memory, write to memory, control an interface, load a program, subroutine, or app, etc. BBU module 1449 performs functions related to message generation and message recovery, and interfacing with the RUs. RU control module 1451 controls operation of the RUs (1st wireless interface module 1414, . . . , Nth wireless interface module 1416) included in access device 1400. Assembly of components 1450, e.g., an assembly of software components, e.g., routines, subroutines, applications, etc., includes, e.g., code, e.g., machine executable instructions, which when executed by processor 1402, controls the access device 1400 to implement steps of a method, e.g., steps of a method which are performed by an access device or portion of an access device, e.g., a RU, described with respect to any of the Figures.

Data/information 1452 includes a received network energy score 1454, corresponding to the network to which access device 1400 belongs, said received network energy score 1454 to be transmitted, e.g., broadcasted, by RUs (1414, . . . , 1416) of access device 1400 to UEs. Data/information 1452 further includes received reports 1456 from UEs communicating information, e.g., RSSI, SINR, network energy scores, UE energy ratings, etc., corresponding to different service provider networks. Data/information 1452 further includes UE handover/network re-selection messages, which may be communicated as part of a UE handover/network re-selection process which, which uses network energy scores and UE energy ratings to make decisions.

Energy network scores and UE energy ratings of communications networks can be generated on a variety of information. Some exemplary ways of generating an energy network score for a network and for a UE generating an energy rating will now be discussed.

### Network Energy Score Computation Examples

In one exemplary embodiment a network energy score is calculates as follows: network energy score for a communications network=(W1×portion of total energy consumed by the communications network attributable to renewable energy sources)+(W2×portion of renewal energy attributable to nuclear energy)+ (W3×portion of total energy consumed by the communications network attributable to non-renewable energy sources (e.g., fossil fuel sources), where W1, W2 and W3 are weights with W1>W2>W3 and where a higher network energy score is preferred in at least some embodiments over lower network energy scores. The range of values which a network energy score can take can be and sometimes is limited to a predetermined range, e.g., 0 to 10, or some other range with the weights being selected so that the computed energy score will fall within the range or with the computed value being limited to the end points of the range when it falls outside the range.

While a network energy score can be computed based on total energy used by the communications network components, e.g., components other than UEs, in other embodiments network energy scores are based on a sum of values generated based on energy usage of non-radio unit network components and access point radio unit components with a fraction of the network energy score for the network being due to portion of energy consumption being summed with the portion or portions of the overall network energy score attribute to radio unit energy consumption.

### UE Energy Rating Computation Examples

Examples of how a UE energy rating can be and sometimes is calculated will now be discussed.

In various embodiments a UE generated energy rating of a communications network is based on a variety of factors such as the amount of energy consumed by the UE to communicate a unit of data and/or other factors such as the QoS obtained for different portions of the data.

In some embodiments the UE generated energy rating of a network is generated by the UE as a weighted sum of values.

For example, in one simple embodiment, an energy rating for the network is determined as:

energy rating (ER) of communications network=(amount of power used by UE to communicate data during a monitoring interval/amount of data communicated by via the communications network during the monitoring time interval)

In some embodiments the monitoring interval is a fixed period of time used for energy measurements. A lower UE calculated ER in such an embodiment indicates a more efficient network from the perspective of UE power consumption per megabyte of data communicated with lower ER communications networks being preferred over less efficient networks with a higher ER in such embodiments.

The UE calculated energy rating of a communications network can be further based on Quality of Service (QOS) associated with communicated data, QoS related factors, or a variety of other factors relating to the communicated data, such as the direction in which the data is communicated (e.g., whether the communicated data is uplink or downlink data) and/or other factors. For example, in some embodiments energy consumption per megabyte of data associated with uplink data is weighted differently than energy consumption per megabyte of data associated with downlink data when a UE generates an energy rating for a communications network.

For example, in one embodiment the UE energy rating for a communications network is computed as follows:

energy rating (ER) of communications network=W4×(amount of power used by UE to communicate uplink data during a monitoring interval/amount of uplink data communicated to the communications network during the monitoring time interval)+W5×(amount of power used by UE to receive downlink data from the communications network during the monitoring interval/amount of downlink data communicated to the UE from the communications network during the monitoring time interval), where W4 is an uplink weight and W5 is a downlink weight which is different from the uplink weight W4, said weights being numeric values.

For example, in one embodiment the UE energy rating for a communications network is computed as follows:

energy rating (ER) of communications network=W6×(amount of power used by UE to communicate data receiving QOS level 1 during a monitoring interval/amount of QOS level 1 data communicated via the communications network during the monitoring time interval)+W7×(amount of power used by UE to communicate QOS level 2 data via the communications network during the monitoring interval/amount of QOS level 2 data communicated via the communications network during the monitoring time interval), where W6 is a first QOS level data weight and W7 is a QOS level 2 data weight which is different from W6, said weights being numeric values.

UE energy ratings can be calculated using a wide range of inputs and/or weights. Various exemplary inputs and weights that can be used in generating a UE energy rating are mentioned in the following example.

energy rating (ER) of communications network=BATTERY PERFORMANCE (instantaneous discharge+battery characteristics (temperature, charge state, capacity)) WEIGHT 1; UE PERFORMANCE (throughput, QoS, . . . ) WEIGHT 2; SERVICE TYPE (streaming, video, gaming, browsing, etc.) WEIGHT 3; TIME AND LOCATION OF THE UE-WEIGHT 4; this is the UE reporting it's current performance energy wise (depending on both the UE state and the current cell/network state) on the current network/cell

Energy ratings can be and sometimes are calculated using one of the above mentioned inputs/parameters/information, any combination of the inputs/parameters/information or all of the inputs/parameters/information mentioned in the above example.

By using network energy scores and/or UE energy ratings in making a communications network selection sources of types of energy being used by network devices and/or the energy efficiency of the network and/or UE in communicating data can be taken into consideration when selecting a network for a UE to use and/or switch to as part of a network handover or network selection process.

In some embodiments a control device, e.g., management node 1516, receives information, e.g. user device power consumption reports or scores relating to communication with various networks. The control device also receives information about a green energy rating of different networks. The control device can and sometime does influence UE device network selection operations by providing power scores and/or green energy scores corresponding to different networks to UE devices. How an individual UE device uses the provided power related information in selecting a network at a given time can be controlled or influenced by the control device by setting policy and/or network selection logic related thresholds or setting on a per UE basis and communicating such information to the UE. Base stations may and sometimes do broadcast network energy scores and/or green energy scores when advertising information used in identifying and/or making network selection decisions. UEs and other wireless devices receive the energy and policy information and make network selection decisions based on the received information and optionally on the device's own previous energy consumption measurements associated with a network. Network switching and/or connection decisions made by devices and/or handover decisions in the network can be and sometimes are based on energy consumption and/or green energy information alone or in combination with other information and/or policy constraints. Scores generated by the network device, e.g., control server, can be and often are based on information provided by multiple different devices, e.g., UEs and/or green energy rating sources.

### First Numbered List of Exemplary Method Embodiments

Method Embodiment 1. A method of operating user equipment (UE) (1956), the method comprising: detecting (505), at the UE (1956), one or more available communications networks (1580, 1582, 1584, 1586); determining (509), from received signals, information corresponding to the one or more detected networks (1580, 1582, 1584, 1586) (e.g., RSSI, SINR, etc. and a network identifier (e.g., PLMN ID) corresponding to each individual detected network), said determined information including for individual detected communications networks: i) a network identifier (e.g., Public Land Mobile Network Identifier (PLMN ID)), ii) a network energy score and iii) signal strength information (e.g., Received Signal Strength Indicator (RSSI), Signal-to-Interference-plus-Noise Ratio (SINR), Reference Signal Received Power (RSRP) and/or Reference Signal Received Quality (RSRQ)); selecting (522) a communications network (1580) from the one or more available communications networks based on network energy scores and network signal strength information; and connecting (524) to the selected communications network
Method Embodiment 2. The method of Method Embodiment 1, wherein the first communications network (1580) is one of the detected available communications networks, and wherein the method further comprises: obtaining (520) a stored UE energy rating (5192) for at least the first communications network (1580) (but in some cases for more than one or all of the available communications networks) (e.g., by retrieving the network energy rating information from a UE energy rating database 519 maintained in storage in the UE 9 (1556)); and wherein selecting (522) a communications network (1580) from the one or more available communications networks is further based on the UE energy rating (5192) for the first communications network.
Method Embodiment 3. The method of Method Embodiment 2, wherein selecting (522) a communications network is further based on UE energy ratings (e.g., 5194) for the other available communications networks.
Method Embodiment 4. The method of Method Embodiment 1, 2 or 3, wherein the selected communications network to which the UE connects is the first communications network (1580), the method comprising: measuring (527) (e.g., at the UE (1556) UE data usage during a monitoring period of time (e.g., monitor data transmission and/or reception to/from a first access point (AP) (e.g., 1514) in the first communications network (1580) during a monitoring period of time, e.g., 10 minutes or some other fixed monitoring time interval (such as an hour or day interval)); measuring (528), at the UE (1556), power consumption during the monitoring period (e.g., measure the amount of power being used by the UE (1556) while communicating via the communications network during the monitoring period, e.g., 10 minutes), said measuring producing a power consumed measurement value corresponding to the monitoring period (and also corresponding to the first communications network (1580) being used for communication during the monitoring period); and calculating (530) at the UE, based on the measured UE data usage and the power consumed measurement value corresponding to the monitoring period, a UE calculated energy rating for the first communications network (1580) (e.g., where the first communications network (1580) is the communications network being used by the UE during the monitoring period of time (e.g., generate a value indicating the amount of power consumed per unit of data transmitted (e.g., milliwatts of power per megabyte of data communicated or some other metric which is a function of both power consumed and data communicated)); and storing (540) the UE calculated energy rating for the first communications network (1580) in the UE energy rating database (519) (Note that UE 9 (1556) may be, and sometimes is, a cell phone or other communications device, used by a user to send data to a first communications network (1580) or receive data from the first communications network (1580) wirelessly via an access point (AP) (e.g., Network 1 Access Device N1 (1514)) such as a base station (e.g., a large cell BS, a small cell base station or a CBSD base station or WiFi AP in the first communications network (1580)).
Method Embodiment 5. The method of Method Embodiment 4, further comprising: generating (529) one or more device usage statistics relating to UE communications via the first communications network (1580) during the monitoring period (e.g., generate measurement information indicating an amount of data transmitted from the UE (1556) to the wireless access point (1514) during the monitoring period, an amount of data received from the first communications network (1580) during the monitoring period via the first wireless access point (1514) in the first communications network (1580) or both an amount of data transmitted by the UE (1556) to the first communications network (1580) during the monitoring period and an amount of data received from the first communications network (1580) during the monitoring period); and wherein calculating (530) at the UE, based on the measured UE data usage and the power consumed measurement value corresponding to the monitoring period, a UE calculated energy rating for the first communications network (1580) includes using one or more of the generated device usage statistics along with the power consumed measurement value to generated the UE calculated energy rating for the first communications network (1580).
Method Embodiment 6. The method of Method Embodiment 4, wherein calculating (530) at the UE, based on the measured UE data usage and the power consumed measurement value corresponding to the monitoring period is further based on information about the energy power source or sources used by the first communications network.
Method Embodiment 7. The method of Method Embodiment 4, further comprising: determining (538) if the UE calculated energy rating for the first communications network (1580) is different from a stored energy rating for the first communications network by at least a first threshold amount; and wherein said step of storing (540) the UE calculated energy rating for the first communications network (1580) in the UE energy rating database (519) is in response to determining that the UE calculated energy rating for the first communications network (1580) is different from the stored energy rating for the first communications network by at least the first threshold amount.
Method Embodiment 8. The method of Method Embodiment 4, further comprising: operating the UE to participate (543) in a network energy score based handover process (e.g., perform UE steps of the method shown in FIG. 8 or 9 which related handover decision making and handover implementation based on network energy rating information.)

The following Method Embodiments relate to FIG. 8 network decision based UE handover or network re-selection and/or FIG. 9 network decision based UE handover or network re-selection process with the steps in some embodiments being performed as part of the method of FIG. 7.
Method Embodiment 9. The method of Method Embodiment 4, further comprising: reporting (604 or 804) to the first communications network (e.g., the communications network to which the UE is connected) parameters corresponding to radio networks detected by the UE, said parameters including signal strength measurements corresponding to the detected networks.
Method Embodiment 10. The method of Method Embodiment 9, wherein the parameters corresponding to the detected radio networks include at least some network energy ratings (e.g., UE energy ratings which was calculated by the UE corresponding to networks for which information is being provided, and/or network energy scores (e.g. received at the UE in one or more broadcast messages) (note: network energy scores are provided in some but not all embodiments since these may be and sometimes are already available in the network) provided along with corresponding network identifiers. (such information is sometimes provided with signal strength measurement information corresponding to the individual identified networks so that the network management device can take into consideration both signal strength corresponding to a network being considered as a handover target in addition to the energy rating corresponding to the energy target and/or the network energy score when making an handover decision for the UE where such a handover decision can also be and sometimes is made further based on other information such as loading of one or more networks which may not be available to the UE but which is available to the network management node making the handoff decision).

Method Embodiments 11-12 relate to network decision based reselection/handover and are supported by FIG. 8.
Method Embodiment 11. The method of Method Embodiment 10, further comprising: operating the UE to receive (612) a handover message indicating a network selected communications network and radio unit identifying a UE handover target (e.g., communications network identified by a Public Land Mobile Network identifier (PLMNID) and a base station identifier, identifying a radio unit in the communications network to be used as a handover target).
Method Embodiment 12. The method of Method Embodiment 10, further comprising: operating the UE to move (614) (e.g., implement and complete a handover/move to the communications network and radio unit) to the identified communications network and radio unit (e.g., by completing a handover to the base station corresponding to the radio unit of the communications network indicated in the handover message as the handover target).

Method Embodiments 13-14 relate to UE decision based network reselection/handover and correspond to FIG. 9.
Method Embodiment 13. The method of Method Embodiment 7, further comprising: receiving (810), at the UE, a list handoff candidates listing potential communications networks and radio units that the UE can handoff to; choosing (812) from the list of handoff candidates a handoff target, based on energy ratings corresponding to the handoff candidates, said handoff target being a chosen network and radio unit of the chosen network; and operating (816) the UE to handoff to the chosen network and radio unit.
Method Embodiment 14. The Method Embodiment of claim 13, wherein choosing (812) from the list of handoff candidates a handoff target is further based on network energy scores corresponding to the communications networks included in the list of handoff candidates.

### First Numbered List of Exemplary Apparatus Embodiments

Apparatus Embodiment 1. A user equipment (UE) (1556 or 900) comprising: a wireless receiver (920) for receiving wireless signals; and a processor (902) configured to operate the UE to: detect (505) one or more available communications networks (1580, 1582, 1584, 1586); determine (509), from received wireless signals, information corresponding to the one or more detected networks (1580, 1582, 1584, 1586) (e.g., RSSI, SINR, etc. and a network identifier (e.g., PLMN ID) corresponding to each individual detected network), said determined information including for individual detected communications networks: i) a network identifier (e.g., Public Land Mobile Network Identifier (PLMN ID)), ii) a network energy score and iii) signal strength information (Received Signal Strength Indicator (RSSI), Signal-to-Interference-plus-Noise Ratio (SINR), Reference Signal Received Power (RSRP) and/or Reference Signal Received Quality (RSRQ)); select (522) a communications network (1580) from the one or more available communications networks based on network energy scores and network signal strength information; and connect (524) to the selected communications network.
Apparatus Embodiment 2. The UE of Apparatus Embodiment 1, wherein the first communications network (1580) is one of the detected available communications networks, and wherein said processor (902) is further configured to operate the UE to: obtain (520) a stored UE energy rating (5192) for at least the first communications network (1580) (but in some cases for more than one or all of the available communications networks) (e.g., by retrieving the network energy rating information from a UE energy rating database 519 maintained in storage in the UE 9 (1556)); and wherein said processor (902) is further configured to base said selecting (522) a communications network (1580) from the one or more available communications networks on the UE energy rating (5192) for the first communications network.
Apparatus Embodiment 3. The UE of Apparatus Embodiment 2, wherein said processor (902) is further configured to base said selecting (522) a communications network on UE energy ratings (e.g., 5194) for the other available communications networks.
Apparatus Embodiment 4. The UE of Apparatus Embodiment 1, 2 or 3, wherein the selected communications network to which the UE connects is the first communications network (1580); and wherein said processor (902) is further configured to operate the UE to: measure (527) (e.g., at the UE (1556) UE data usage during a monitoring period of time (e.g., monitor data transmission and/or reception to/from a first access point (AP) (e.g., 1514) in the first communications network (1580) during a monitoring period of time, e.g., 10 minutes or some other fixed monitoring time interval (such as an hour or day interval)); measure (528), at the UE (1556), power consumption during the monitoring period (e.g., measure the amount of power being used by the UE (1556) while communicating via the communications network during the monitoring period, e.g., 10 minutes), said measuring producing a power consumed measurement value corresponding to the monitoring period (and also corresponding to the first communications network (1580) being used for communication during the monitoring period); and calculate (530), based on the measured UE data usage and the power consumed measurement value corresponding to the monitoring period, a UE calculated energy rating for the first communications network (1580) (e.g., where the first communications network (1580) is the communications network being used by the UE during the monitoring period of time (e.g., generate a value indicating the amount of power consumed per unit of data transmitted (e.g., milliwatts of power per megabyte of data communicated or some other metric which is a function of both power consumed and data communicated)); and store (540) the UE calculated energy rating for the first communications network (1580) in the UE energy rating database (519) (Note that UE 9 (1556) may be, and sometimes is, a cell phone or other communications device, used by a user to send data to a first communications network (1580) or receive data from the first communications network (1580) wirelessly via an access point (AP) (e.g., Network 1 Access Device N1 (1514)) such as a base station (e.g., a large cell BS, a small cell base station or a CBSD base station or WiFi AP in the first communications network (1580)).
Apparatus Embodiment 5. The UE of Apparatus Embodiment 4, wherein said processor (902) is further configured to operate the UE to: generate (529) one or more device usage statistics relating to UE communications via the first communications network (1580) during the monitoring period (e.g., generate measurement information indicating an amount of data transmitted from the UE (1556) to the wireless access point (1514) during the monitoring period, an amount of data received from the first communications network (1580) during the monitoring period via the first wireless access point (1514) in the first communications network (1580) or both an amount of data transmitted by the UE (1556) to the first communications network (1580) during the monitoring period and an amount of data received from the first communications network (1580) during the monitoring period); and wherein said processor (902) is further configured to use one or more of the generated device usage statistics along with the power consumed measurement value to generate the UE calculated energy rating for the first communications network (1580), as part of being configured to calculate (530) based on the measured UE data usage and the power consumed measurement value corresponding to the monitoring period, a UE calculated energy rating for the first communications network (1580).
Apparatus Embodiment 6. The UE of Apparatus Embodiment 4, wherein calculating (530) at the UE, based on the measured UE data usage and the power consumed measurement value corresponding to the monitoring period is further based on information about the energy power source or sources used by the first communications network.
Apparatus Embodiment 7. The UE of Apparatus Embodiment 4, wherein said processor (902) is further configured to operate the UE to: determine (538) if the UE calculated energy rating for the first communications network (1580) is different from a stored energy rating for the first communications network by at least a first threshold amount; and wherein said step of storing (540) the UE calculated energy rating for the first communications network (1580) in the UE energy rating database (519) is in response to determining that the UE calculated energy rating for the first communications network (1580) is different from the stored energy rating for the first communications network by at least the first threshold amount.
Apparatus Embodiment 8. The UE of Apparatus Embodiment 4, wherein said processor (902) is further configured to operate the UE to: participate (543) in a network energy score based handover process (e.g., perform UE steps of the method shown in FIG. 8 or 9 which related handover decision making and handover implementation based on network energy rating information.)

The following Apparatus Embodiments relate to FIG. 8 network decision based UE handover or network re-selection and/or FIG. 9 network decision based UE handover or network re-selection process with the steps in some embodiments being performed as part of FIG. 7.
Apparatus Embodiment 9. The UE of Apparatus Embodiment 4, wherein said processor (902) is further configured to operate the UE to: report (604 or 804) to the first communications network (e.g., the communications network to which the UE is connected) parameters corresponding to radio networks detected by the UE, said parameters including signal strength measurements corresponding to the detected networks.
Apparatus Embodiment 10. The UE of Apparatus Embodiment 9, wherein the parameters corresponding to the detected radio networks include at least some network energy ratings (e.g., UE energy ratings which was calculated by the UE corresponding to networks for which information is being provided, and/or network energy scores (e.g. received at the UE in one or more broadcast messages) (note: network energy scores are provided in some but not all embodiments since these may be and sometimes are already available in the network) provided along with corresponding network identifiers. (such information is sometimes provided with signal strength measurement information corresponding to the individual identified networks so that the network management device can take into consideration both signal strength corresponding to a network being considered as a handover target in addition to the energy rating corresponding to the energy target and/or the network energy score when making an handover decision for the UE where such a handover decision can also be and sometimes is made further based on other information such as loading of one or more networks which may not be available to the UE but which is available to the network management node making the handoff decision).

Apparatus Embodiments 11-12 relate to network decision based reselection/handover and are supported by the steps in FIG. 8.
Apparatus Embodiment 11. The UE of Apparatus Embodiment 10, wherein said processor (902) is further configured to operate the UE to: receive (612) (e.g., via wireless receiver 920) a handover message indicating a network selected communications network and radio unit identifying a UE handover target (e.g., communications network identified by a PLMID and a base station identifier, identifying a radio unit in the communications network to be used as a handover target).
Apparatus Embodiment 12. The UE of Apparatus Embodiment 10, wherein said processor (902) is further configured to: operate the UE to move (614) (e.g., implement and complete a handover/move to the communications network and radio unit) to the identified communications network and radio unit (e.g., by completing a handover to the base station corresponding to the radio unit of the communications network indicated in the handover message as the handover target).

Apparatus Embodiments 13-14 relates to UE decision based network reselection/handover and are supported by the seps of FIG. 9.
Apparatus Embodiment 13. The UE of Apparatus Embodiment 7, wherein said processor (902) is further configured to operate the UE to: receive (810) (via wireless receiver 920) a list handoff candidates listing potential communications networks and radio units that the UE can handoff to; choose (812) from the list of handoff candidates a handoff target, based on energy ratings corresponding to the handoff candidates, said handoff target being a chosen network and radio unit of the chosen network; and handoff (816) to the chosen network and radio unit.
Apparatus Embodiment 14. The UE of Apparatus Embodiment 13, wherein said processor (902) is further configured to base said choosing (812) from the list of handoff candidates a handoff target, on network energy scores corresponding to the communications networks included in the list of handoff candidates.

### Second Numbered List of Exemplary Method Embodiments

Method Embodiment 1. A method of facilitating communication using one or more networks (1580, 1582, 1584, 1586), the method comprising: calculating (408) (e.g., in a network device such as a management node (1516) in communications network 1 (1580)) an energy score for a first communications network based on i) an energy mix (404) used to supply energy to radio units in the first communications network; ii) an energy mix used to supply energy to additional network components (406) of the first network (e.g., network nodes and devices other than radio units) or iii) both the energy mix (404) used to supply energy to radio units in the first communications network and energy mix used to supply energy to additional network components (406) of the first network; communicating (410) the energy score for the first communications network to base stations (1510, 1512, 1514) in the first communications network; and operating radio units (RU 15101, RU 15121, RU 15141) in the base stations (1510, 1512, 1514) of the first communications network (1580) to communicate the energy score for the first communications network to one or more UE devices in the first communications network.
Method Embodiment 2. The method of Method Embodiment 1, wherein said energy score for the first communications network is a numeric value generated based on an amount or fraction of total energy used (e.g., 20% of the total energy used to power the radio units in the first communications network) to power radio units in said network which is attributable to renewable energy sources (e.g., wind and/or solar sources) and on another amount of total energy used (e.g., 80% of the total energy used to power the radio units in the first communications network) to power radio units in said network which is attributable to non-renewable energy sources (e.g., coal, gas or oil).
Method Embodiment 3. The method of Method Embodiment 2, wherein said energy score for the first communications network is further based on an amount or fraction of total energy used (e.g., 40% of the total energy used to power network components other than radio units in the first communications network) which is attributable to renewable energy sources (e.g., wind and/or solar sources) and on another amount of total energy used (e.g., 60% of the total energy used to power the network components other than radio units in the first communications network)) to power the network components other than radio units in the first communications network which is attributable to non-renewable energy sources (e.g., coal, gas or oil).
Method Embodiment 4. The method of Method Embodiment 1, wherein operating radio units (RU 15101, RU 15121, RU 15141) in the base stations (1510, 1512, 1514) of the first communications network (1580) to communicate the energy score for the first communications network to one or more UE devices in the first communications network includes broadcasting the energy score for the first communications network as part of first network system information transmitted in a broadcast signal to User Equipments (UEs).
Method Embodiment 5. The method of Method Embodiment 1, wherein operating radio units (RU 15101, RU 15121, RU 15141) in the base stations (1510, 1512, 1514) of the first communications network (1580) to communicate the energy score for the first communications network to one or more UE devices in the first communications network includes transmitting the energy score for the first communications network to a first UE (1556).
Method Embodiment 6. The method of Method Embodiment 1, wherein the calculating (408) and communicating (410) steps are performed by a first network management node (1516) of the first communications network (1580), the method further comprising: operating the first network management node (1516) to communicate (420) the energy score for the first communications network to one or more other network management nodes (1522, 1528, 1532).
Method Embodiment 7. The method of Method Embodiment 1, wherein the one or more other network management nodes (1522, 1528, 1532) includes a second network management node (1522) corresponding to a second communications network (1582).
Method Embodiment 8. The method of Method Embodiment 2, further comprising: operating a first network management node (1516) to select (606) a handover target for a first UE based on network energy scores corresponding to different communications networks (1580, 1582, 1584, 1586).
Method Embodiment 9. The method of Method Embodiment 8, further comprising: prior to operating the first network management node (1516) to select (606) a handover target for a first UE based on network energy scores corresponding to different communications networks (1580, 1582, 1584, 1586), receiving (605) at the first network management node (1516) UE energy ratings corresponding to at least some of said different communications networks (1580, 1582, 1584, 1586); and wherein said step of selecting (606) a handover target for a first UE is further based on the received UE energy ratings corresponding to the different communications networks (1580, 1582, 1584, 1586).

### Numbered List of Exemplary System Embodiments

System Embodiment 1. A communications system (1500) comprising: a first network management node (1516 or 1100) including: a transmitter (1118); a receiver (1116); and a first processor (1102); a base station (1510) including: a radio unit (15101); and a second processor (1402); and wherein first processor (1102) is configured to operate the first network management device to: calculate (408) an energy score for a first communications network (1580) based on i) an energy mix (404) used to supply energy to radio units in the first communications network; ii) an energy mix used to supply energy to additional network components (406) of the first network (e.g., network nodes and devices other than radio units) or iii) both the energy mix (404) used to supply energy to radio units in the first communications network and energy mix used to supply energy to additional network components (406) of the first network; and communicate (410) (via transmitter 1118) the energy score for the first communications network to the base stations (1510) in the first communications network; and wherein said second processor (1402) is configured to: operate the radio unit (RU 15101) in the base station (1510) of the first communications network (1580) to communicate the energy score for the first communications network to one or more UE devices (1556, 1558, 1560, 1562) in the first communications network.
System Embodiment 2. The communications system of System Embodiment 1, wherein said energy score for the first communications network is a numeric value generated based on an amount or fraction of total energy used (e.g., 20% of the total energy used to power the radio units in the first communications network) to power radio units in said network which is attributable to renewable energy sources (e.g., wind and/or solar sources) and on another amount of total energy used (e.g., 80% of the total energy used to power the radio units in the first communications network) to power radio units in said network which is attributable to non-renewable energy sources (e.g., coal, gas or oil).
System Embodiment 3. The communications system of System Embodiment 2, wherein said energy score for the first communications network is further based on an amount or fraction of total energy used (e.g., 40% of the total energy used to power network components other than radio units in the first communications network) which is attributable to renewable energy sources (e.g., wind and/or solar sources) and on another amount of total energy used (e.g., 60% of the total energy used to power the network components other than radio units in the first communications network)) to power the network components other than radio units in the first communications network which is attributable to non-renewable energy sources (e.g., coal, gas or oil).
System Embodiment 4. The communications system of System Embodiment 1, wherein said second processor (1402) is configured to: operate the RU (15101) in base station (1510) to broadcast the energy score for the first communications network as part of first network system information transmitted in a broadcast signal to User Equipments (UEs), as part of being configured to operate the radio unit (RU 15101) in the base station (1510 of the first communications network (1580) to communicate the energy score for the first communications network to one or more UE devices in the first communications network.
System Embodiment 5. The communications system of System Embodiment 1, wherein said second processor (1402) is configured to operate the RU (15101) in the base station (1510) to transmit the energy score for the first communications network to a first UE (1556), as part of being configured to operate the radio unit (RU 15101) in the base stations (1510) of the first communications network (1580) to communicate the energy score for the first communications network to one or more UE devices in the first communications network.
System Embodiment 6. The communications system of System Embodiment 1, wherein said first processor (1102) is further configured to operate the first network management node (1516) to communicate (420) the energy score for the first communications network to one or more other network management nodes (1522, 1528, 1532).
System Embodiment 7. The communications system of System Embodiment 1, wherein the one or more other network management nodes (1522, 1528, 1532) includes a second network management node (1522) corresponding to a second communications network (1582).
System Embodiment 8. The communications system of System Embodiment 2, wherein said first processor (1102) is further configured to: operate the first network management node (1516) to select (606) a handover target for a first UE based on network energy scores corresponding to different communications networks (1580, 1582, 1584, 1586).
System Embodiment 9. The communications system of System Embodiment 8, wherein said first processor (1102) is further configured to: prior to operating the first network management node (1516) to select (606) a handover target for a first UE based on network energy scores corresponding to different communications networks (1580, 1582, 1584, 1586), operate the first network management node (1516) to receive (605) UE energy ratings corresponding to at least some of said different communications networks (1580, 1582, 1584, 1586); and wherein said first processor (1102) is configured to base said selecting (606) a handover target for a first UE, on the received UE energy ratings corresponding to the different communications networks (1580, 1582, 1584, 1586).

In various embodiments an embedded device such as an embedded-SIM (eSIM) or embedded universal integrated circuit card (eUICC) is used. In such cases the embedded device can be in the form of programmable SIM card that is embedded directly into a device. In machine-to-machine (M2M) applications, where there is no requirement to change the SIM card, this avoids the requirement for a connector. This improves reliability, network security and security, while also reducing space requirements, since a relatively bulky connector is no longer needed, increasing design flexibility. An eSIM can be provisioned remotely; end-users can add or remove operators without the need to physically swap a SIM from the device. eSIM is a global specification by the GSMA which enables remote SIM provisioning of any mobile device. GSMA defines eSIM as the SIM for the next generation of connected consumer device. Networking solutions using eSIM technology can be widely applicable to various Internet of Things (IOT) scenarios, including connected cars (smart rearview mirrors, on-board diagnostics (OBD), vehicle Wi-Fi hotspots), as well as artificial intelligence translators, MiFi devices, smart earphones, smart metering, GPS tracking units, DTU, bike-sharing, advertising players, video surveillance devices, etc.

Various embodiments are directed to apparatus, e.g., control devices such as control servers, management nodes, access points (APs), e.g., WiFi APs, base stations such as NRU gNB base stations, etc., user devices such as stations (STAs), e.g., WiFi STAs, user equipment (UE) devices, LTE LAA devices, various types of RLAN devices, etc., other network communications devices such as routers, switches, etc., mobile network operator (MNO) base stations (macro cell base stations and small cell base stations) such as a Evolved Node B (eNB), gNB or ng-eNB, mobile virtual network operator (MVNO) base stations such as Citizens Broadband Radio Service Devices (CBSDs), network nodes, MNO and MVNO HSS devices, relay devices, e.g. mobility management entities (MMEs), a Spectrum Access System (SAS), an AFC system, an Access and Mobility Management Function (AMF) device, servers, customer premises equipment devices, cable systems, network nodes, gateways, cable headend and/or hubsites, network monitoring nodes and/or servers, cluster controllers, cloud nodes, production nodes, cloud services servers and/or network equipment devices. Various embodiments are also directed to methods, e.g., method of controlling and/or operating control devices, e.g. control servers, management nodes, access points (APs), e.g., WiFi APs, base stations such as NRU gNB base stations, etc., user devices such as stations (STAs), e.g., WiFi STAs, user equipment (UE) devices, LTE LAA devices, various types of RLAN devices, network communications devices such as routers, switches, etc., user devices, base stations, e.g., eNB and CBSDs, gateways, servers (HSS server), MMEs, SAS, an AFC system, cable networks, cloud networks, nodes, servers, cloud service servers, customer premises equipment devices, controllers, network monitoring nodes and/or servers and/or cable or network equipment devices.

Various embodiments are directed to communications network which are partners, e.g., a MVNO network and a MNO network. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements are steps are implemented using hardware circuitry.

In various embodiments nodes and/or elements described herein are implemented using one or more components to perform the steps corresponding to one or more methods, for example, message reception, message generation, signal generation, signal processing, sending, comparing, determining and/or transmission steps. Thus, in some embodiments various features are implemented using components or in some embodiment's logic such as for example logic circuits. Such components may be implemented using software, hardware or a combination of software and hardware.

Many of the above-described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a control device such as a control server, a management node, an access points (AP), e.g., WiFi AP, base stations such as NRU gNB base station, etc., a user device such as a station (STA), e.g., WiFi STA, a user equipment (UE) device, LTE LAA device, etc., an RLAN device, other network communications devices a network communications device such as router, switch, etc., a MVNO base station such as a CBRS base station, e.g., a CBSD, a device such as a cellular base station e.g., an eNB, a MNO HSS server, a MVNO HSS server, a UE device, a relay device, e.g. a MME, SAS, a AFC system, etc., said device including a processor configured to implement one, multiple or all of the steps of one or more methods of the invention.

In some embodiments, the processor or processors, e.g., CPUs, of one or more devices, e.g., control devices such as control servers, management nodes, communications nodes such as e.g., access points (APs), e.g., WiFi APs, base stations such as NRU gNB base stations, etc., user devices such as stations (STAs), e.g., WiFi STAs, user equipment (UE) devices, LTE LAA devices, etc., various RLAN devices, network communications devices such as routers, switches, etc., a MVNO base station such as a CBRS base station, e.g. a CBSD, an device such as a cellular base station e.g., an eNB, a MNO HSS server, a MVNO HSS device server, a UE device, a relay device, e.g. a MME, a SAS, a AFC system, are configured to perform the steps of the methods described as being performed by the communications nodes, e.g., controllers. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., a control device such as a control server, a management node, an access points (AP), e.g., WiFi AP, a base station such as NRU gNB base station, etc., a user device such as station (STA), e.g., WiFi STA, a user equipment (UE) device, an LTE LAA device, etc., a RLAN device, a network communications device such as router, switch, etc., administrator device, security device, a MVNO base station such as a CBRS base station, e.g. a CBSD, an device such as a cellular base station e.g., an eNB, a MNO HSS server, a MVNO HSS device server, a UE device, a relay device, e.g. a MME, includes a component corresponding to each of one or more of the steps of the various described methods performed by the device in which the processor is included. In some but not all embodiments a device, e.g., a control device such a control server, a management node, a communications node such as e.g., an access points (AP), e.g., WiFi AP, a base station such as NRU gNB base station, etc., a user device such as a station (STA), e.g., WiFi STA, a user equipment (UE) device, a LTE LAA device, a RLAN device, a router, switch, etc., administrator device, security device, a AFC system, a MVNO base station such as a CBRS base station, e.g., a CBSD, a device such as a cellular base station e.g., an eNB, an MNO HSS server, a MVNO HSS device server, a UE device, a relay device, e.g. a MME, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a control device such as a control server, a management node, a communications device such as a communications nodes such as e.g., an access point (AP), e.g., WiFi AP, a base station such as NRU gNB base station, etc., a user device such as a station (STA), e.g., WiFi STA, a user equipment (UE) device, a LTE LAA device, etc., an RLAN device, a network communications device such as router, switch, etc., administrator device, security device, a AFC system, MNVO base station, e.g., a CBSD, an MNO cellular base station, e.g., an eNB or a gNB, a HSS server, a UE device, a SAS or other device described in the present application. In some embodiments, components are implemented as hardware devices in such embodiments the components are hardware components. In other embodiments components may be implemented as software, e.g., a set of processor or computer executable instructions.

Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating user equipment (UE), the method comprising:
detecting, at the UE, one or more available communications networks;
determining, from received signals, information corresponding to the one or more detected networks, said determined information including for individual detected communications networks: i) a network identifier, ii) a network energy score and iii) signal strength information;
selecting a communications network from the one or more available communications networks based on network energy scores and network signal strength information; and
connecting to the selected communications network.

2. The method of claim 1,
wherein the first communications network is one of the detected available communications networks, and
wherein the method further comprises:
obtaining a stored UE energy rating for at least the first communications network; and
wherein selecting a communications network from the one or more available communications networks is further based on the UE energy rating for the first communications network.

3. The method of claim 2, wherein selecting a communications network is further based on UE energy ratings for the other available communications networks.

4. The method of claim 1, wherein the selected communications network to which the UE connects is the first communications network, the method comprising:
measuring UE data usage during a monitoring period of time;
measuring, at the UE, power consumption during the monitoring period, said measuring producing a power consumed measurement value corresponding to the monitoring period; and
calculating at the UE, based on the measured UE data usage and the power consumed measurement value corresponding to the monitoring period, a UE calculated energy rating for the first communications network; and
storing the UE calculated energy rating for the first communications network in the UE energy rating database.

5. The method of claim 4, further comprising:
generating one or more device usage statistics relating to UE communications via the first communications network during the monitoring period; and
wherein calculating at the UE, based on the measured UE data usage and the power consumed measurement value corresponding to the monitoring period, a UE calculated energy rating for the first communications network includes using one or more of the generated device usage statistics along with the power consumed measurement value to generate the UE calculated energy rating for the first communications network.

6. The method of claim 4, wherein calculating at the UE, based on the measured UE data usage and the power consumed measurement value corresponding to the monitoring period is further based on information about the energy power source or sources used by the first communications network.

7. The method of claim 4, further comprising:
determining if the UE calculated energy rating for the first communications network is different from a stored energy rating for the first communications network by at least a first threshold amount; and
wherein said step of storing the UE calculated energy rating for the first communications network in the UE energy rating database is in response to determining that the UE calculated energy rating for the first communications network is different from the stored energy rating for the first communications network by at least the first threshold amount.

8. The method of claim 4, further comprising:
reporting to the first communications network parameters corresponding to radio networks detected by the UE, said parameters including signal strength measurements corresponding to the detected networks.

9. The method of claim 8, wherein the parameters corresponding to the detected radio networks include at least some network energy ratings provided along with corresponding network identifiers.

10. A user equipment (UE) comprising:
a wireless receiver for receiving wireless signals; and
a processor configured to operate the UE to:
detect one or more available communications networks;
determine, from received wireless signals, information corresponding to the one or more detected networks, said determined information including for individual detected communications networks: i) a network identifier, ii) a network energy score and iii) signal strength information;
select a communications network from the one or more available communications networks based on network energy scores and network signal strength information; and
connect to the selected communications network.

11. The UE of claim 10,
wherein the first communications network is one of the detected available communications networks, and
wherein said processor is further configured to operate the UE to:
obtain a stored UE energy rating for at least the first communications network; and
wherein said processor is further configured to base said selecting a communications network from the one or more available communications networks on the UE energy rating for the first communications network.

12. The UE of claim 11, wherein said processor is further configured to base said selecting a communications network on UE energy ratings for the other available communications networks.

13. The UE of claim 10, wherein the selected communications network to which the UE connects is the first communications network; and
wherein said processor is further configured to operate the UE to:
measure UE data usage during a monitoring period of time;
measure, at the UE, power consumption during the monitoring period, said measuring producing a power consumed measurement value corresponding to the monitoring period; and
calculate, based on the measured UE data usage and the power consumed measurement value corresponding to the monitoring period, a UE calculated energy rating for the first communications network; and
store the UE calculated energy rating for the first communications network in the UE energy rating database.

14. The UE of claim 13, wherein said processor is further configured to operate the UE to:
generate one or more device usage statistics relating to UE communications via the first communications network during the monitoring period; and
wherein said processor is further configured to use one or more of the generated device usage statistics along with the power consumed measurement value to generate the UE calculated energy rating for the first communications network, as part of being configured to calculating based on the measured UE data usage and the power consumed measurement value corresponding to the monitoring period, a UE calculated energy rating for the first communications network.

15. The UE of claim 13, wherein calculating at the UE, based on the measured UE data usage and the power consumed measurement value corresponding to the monitoring period is further based on information about the energy power source or sources used by the first communications network.

16. A method of facilitating communication using one or more networks, the method comprising:
calculating an energy score for a first communications network based on: i) an energy mix used to supply energy to radio units in the first communications network; ii) an energy mix used to supply energy to additional network components of the first network or iii) both the energy mix used to supply energy to radio units in the first communications network and energy mix used to supply energy to additional network components of the first network;
communicating the energy score for the first communications network to base stations in the first communications network; and
operating radio units in the base stations of the first communications network to communicate the energy score for the first communications network to one or more UE devices in the first communications network.

17. The method of claim 16, wherein said energy score for the first communications network is a numeric value generated based on an amount or fraction of total energy used to power radio units in said network which is attributable to renewable energy sources and on another amount of total energy used to power radio units in said network which is attributable to non-renewable energy sources.

18. The method of claim 17, wherein said energy score for the first communications network is further based on an amount or fraction of total energy used which is attributable to renewable energy sources and on another amount of total energy used to power the network components other than radio units in the first communications network which is attributable to non-renewable energy sources.

19. The method of claim 16, wherein operating radio units in the base stations of the first communications network to communicate the energy score for the first communications network to one or more UE devices in the first communications network includes broadcasting the energy score for the first communications network as part of first network system information transmitted in a broadcast signal to User Equipments (UEs).

20. The method of claim 16, wherein operating radio units in the base stations of the first communications network to communicate the energy score for the first communications network to one or more UE devices in the first communications network includes transmitting the energy score for the first communications network to a first UE.

21. The method of claim 16, wherein the calculating and communicating steps are performed by a first network management node of the first communications network, the method further comprising:
operating the first network management node to communicate the energy score for the first communications network to one or more other network management nodes.

22. The method of claim 17, further comprising:
operating a first network management node to select a handover target for a first UE based on network energy scores corresponding to different communications networks.

23. The method of claim 22, further comprising:
prior to operating the first network management node to select a handover target for a first UE based on network energy scores corresponding to different communications networks, receiving at the first network management node UE energy ratings corresponding to at least some of said different communications networks; and
wherein said step of selecting a handover target for a first UE is further based on the received UE energy ratings corresponding to the different communications networks.

24. A communications system comprising:
a first network management node including:
a transmitter;
a receiver; and
a first processor;
a base station including:
a radio unit; and
a second processor; and
wherein first processor is configured to operate the first network management device to:
calculate an energy score for a first communications network based on: i) an energy mix used to supply energy to radio units in the first communications network; ii) an energy mix used to supply energy to additional network components of the first network or iii) both the energy mix used to supply energy to radio units in the first communications network and energy mix used to supply energy to additional network components of the first network; and
communicate the energy score for the first communications network to the base stations in the first communications network; and
wherein said second processor is configured to: operate the radio unit in the base station of the first communications network to communicate the energy score for the first communications network to one or more UE devices in the first communications network.

25. The communications system of claim 24, wherein said energy score for the first communications network is a numeric value generated based on an amount or fraction of total energy used to power radio units in said network which is attributable to renewable energy sources and on another amount of total energy used to power radio units in said network which is attributable to non-renewable energy sources.

26. The communications system of claim 25, wherein said energy score for the first communications network is further based on an amount or fraction of total energy used which is attributable to renewable energy sources and on another amount of total energy used to power the network components other than radio units in the first communications network which is attributable to non-renewable energy sources.

27. The communications system of claim 24, wherein said second processor is configured to: operate the RU in base station to broadcast the energy score for the first communications network as part of first network system information transmitted in a broadcast signal to User Equipments (UEs), as part of being configured to operate the radio unit in the base station to communicate the energy score for the first communications network to one or more UE devices in the first communications network.

28. The communications system of claim 24, wherein said second processor is configured to operate the RU in the base station to transmit the energy score for the first communications network to a first UE, as part of being configured to operate the radio unit in the base stations of the first communications network to communicate the energy score for the first communications network to one or more UE devices in the first communications network.

29. The communications system of claim 24, wherein said first processor is further configured to operate the first network management node to communicate the energy score for the first communications network to one or more other network management nodes.

30. The communications system of claim 25, wherein said first processor is further configured to:
operate the first network management node to select a handover target for a first UE based on network energy scores corresponding to different communications networks.
